(19) United States
(12) Patent Application Publication
(10) Pub. No.: US 2024/0196011 A1
(43) Pub. Date: Jun. 13, 2024

(54) METHODS AND APPARATUSES FOR ENCODING/DECODING A SEQUENCE OF MULTIPLE PLANE IMAGES, METHODS AND APPARATUS FOR RECONSTRUCTING A COMPUTER GENERATED HOLOGRAM

(71) Applicant: InterDigital CE Patent Holdings, SAS, paris (FR)

(72) Inventors: Valter Drazic, Betton (FR); Didier Doyen, Cesson-Sevigne (FR); Guillaume Boisson, Pleumeleuc (FR); Valerie Allie, Saint-Armel (FR); Vincent Brac De La Perriere, Rennes (FR)

(21) Appl. No.: 18/285,798

(22) PCT Filed: Mar. 29, 2022
(86) PCT No.: PCT/EP2022/058322

§ 371 Date: Oct. 5, 2023

(30) Foreign Application Priority Data
Apr. 9, 2021 (EP) 21305464.6

(51) Int. Cl. H04N 19/597; H04N 19/119; H04N 19/184; H04N 19/30

(52) U.S. Cl. CPC H04N 19/597; H04N 19/119; H04N 19/184; H04N 19/30

(57) ABSTRACT

Methods (1400) and apparatuses for encoding/decoding a sequence of multiple plane images representative of a 3D scene are provided, wherein the sequence of multiple plane images comprises at least one multiple plane image. a multiple plane image comprising a plurality of layers. said encoding comprising encoding in a bitstream. for at least one layer of the plurality of layers of the at least one multiple plane image. an indicator indicating whether the at least one layer has changed with respect to a corresponding layer of a reference multiple plane image, and encoding the at least one multiple plane image. Methods (1100) and apparatuses for reconstructing Computer Generated Holograms from the sequence of multiple plane images are also provided.

### TECHNICAL FIELD

The present embodiments generally relate the domain of three-dimensional (3D) scene and volumetric video content, including holographic representation. The present embodiments generally relate to methods and apparatuses for encoding and decoding multiple plane images representative of a 3D scene. More particularly, the present embodiments relate to methods and apparatuses for encoding/decoding/reconstructing Computer Generated Hologram from multiple plane images.

### BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art. A multiplane image (MPI) is a layered representation of a volumetric scene where each layer is actually a slice of the 3D space of the scene. Each slice is sampled according to an underlying central projection (e.g. perspective, spherical, . . . ) and a sampling law which defines the interlayer spacing. A layer comprises texture (i.e. color information) as well as transparency information of any 3D intersecting object of the scene. From this sliced representation, it is possible to recover/synthesize any viewpoint located in a limited region around the center of the underlying projection. It can be performed making use of efficient algorithms (e.g. “reversed” Painter's algorithm) which blends each layer with the proper weights (i.e. transparency) starting from the nearest to the furthest layer. Such techniques may run very much faster than other known view synthesis processes.

Different approaches, like the MIV standard (ISO/IEC CD 23090-12, Information technology—Coded Representation of Immersive Media—Part 12: MPEG Immersive Video, N19482, 4 July 2020) may already be used to transport immersive video content represented in a MPI format without any syntax modification. Only the transparency attribute, for instance, provisioned in the V3C (ISO/IEC FDIS 23090-5, Information technology—Coded Representation of Immersive Media—Part 5: Visual Volumetric Video-based Coding (V3C) and Video-based Point Cloud Compression (V-PCC), N19579, 4 July 2020) mother specification of MIV, has to be activated. The MPI may be conveyed as two video bitstreams respectively encoding texture and transparency patch atlas images. The depth (i.e. the geometry data corresponding to a distance between projected points of the 3D scene and the projection surface or projection center) of each patch is constant (because of the principles of MPI encoding) and may be signaled, for example, in an atlas information data stream and/or in metadata of one of the data streams or in metadata of one data stream encoding the two sequences of atlases in different tracks.

The principle of Digital Holography (DH) is to reconstruct the exact same light wave front emitted by a 3-dimensional object. This wave front carries all the information on parallax and distance. Both types of information are lost by 2-dimensional conventional imaging systems (digital cameras, 2 dimensional images . . . ), and only parallax can be retrieved using recent multi-view light-field displays. The impossibility of such displays to render both parallax and depth cues leads to convergence-accommodation conflict, which can cause eye strain, headache, nausea and lack of realism.

Holography is historically based on the recording of the interferences created by a reference beam, coming from a coherent light source, and an object beam, formed by the reflection of the reference beam on the subject. The interference pattern was recorded in photosensitive material, and locally (microscopically) looks like a diffraction grating, with a grating pitch of the order of the wavelength used for the recording. Once this interference pattern has been recorded, its illumination by the original reference wave re-creates the object beam, and the original wave front of the 3D object.

The original concept of holography evolved into the modern concept of Digital Holography. The requirements of high stability and photosensitive material made holography impractical for the display of dynamic 3D content. With the emergence of liquid crystal displays, the possibility of modulating the phase of an incoming wave front, and thus of shaping it at will, made it possible to recreate interference patterns on dynamic devices. The hologram can this time be computed and referred to as a Computer-Generated Hologram (CGH). The synthesis of CGH requires the computation of the interference pattern that was previously recorded on photosensitive material, which can be done through various methods using Fourier optics. The object beam (i.e., the 3D image) can be obtained, for example, by illuminating a liquid crystal on silicon spatial light modulator (LCOS SLM) display bearing the CGH with the reference beam.

### SUMMARY

According to an aspect, a method for encoding a sequence of multiple plane images representative of a 3D scene, is provided, wherein the sequence of multiple plane images comprises at least one multiple plane image, a multiple plane image comprising a plurality of layers. The encoding comprises encoding in a bitstream, for at least one layer of the plurality of layers of the at least one multiple plane image, an indicator indicating whether the at least one layer has changed with respect to a corresponding layer of a reference multiple plane image, encoding the at least one multiple plane image.

The scene is dynamic, in that it evolves over time. In that way, the sequence of multiple plane images is a sequence of temporal multiple plane images.

According to another aspect, an apparatus for encoding a sequence of multiple plane images representative of a 3D scene is provided, wherein the sequence of multiple plane images comprises at least one multiple plane image, a multiple plane image comprising a plurality of layers, the apparatus comprising one or more processors configured for encoding in a bitstream, for at least one layer of the plurality of layers of the at least one multiple plane image, an indicator indicating whether the at least one layer has changed with respect to a corresponding layer of a reference multiple plane image, encoding the at least one multiple plane image.

According to another aspect, a method for decoding a sequence of multiple plane images representative of a 3D scene is provided, wherein the sequence of multiple plane images comprises at least one multiple plane image, a multiple plane image comprising a plurality of layers, said decoding comprising decoding from a bitstream, for at least one layer of the plurality of layers of the at least one multiple plane image, an indicator indicating whether the at least one layer has changed with respect to a corresponding layer of a reference multiple plane image.

According to another aspect, an apparatus for decoding a sequence of multiple plane images representative of a 3D scene is provided, wherein the sequence of multiple plane images comprises at least one multiple plane image, a multiple plane image comprising a plurality of layers, the apparatus comprising one or more processors configured for decoding from a bitstream, for at least one layer of the plurality of layers of the at least one multiple plane image, an indicator indicating whether the at least one layer has changed with respect to a corresponding layer of a reference multiple plane image.

In all the embodiments described herein, the 3D scene is dynamic, in that it evolves over time. In that way, the sequence of multiple plane images is a sequence of temporal multiple plane images.

According to another aspect, a method for reconstructing at least one Computer Generated Hologram from a multi-layer image is provided, wherein reconstructing the at least one Computer Generated Hologram comprises obtaining at least one layer of a multi-layer Computer Generated Hologram. According to an embodiment, responsive to a determination that a layer of the multi-layer image corresponding to the at least one layer of the multi-layer Computer Generated Hologram, has not changed with respect to a corresponding layer of a reference multi-layer image, the at least one layer of the multi-layer Computer Generated Hologram is obtained from a corresponding layer of a reference multi-layer Computer Generated Hologram, the reference multi-layer Computer Generated Hologram being previously reconstructed from the reference multi-layer image.

According to another embodiment, the multi-layer Computer Generated Hologram comprises a plurality of ordered layers, with a first layer being a layer that is a closest layer among the plurality of layers from a plane of the at least one Computer Generated Hologram and a last layer being a farthest layer among the plurality of layers from a plane of the at least one Computer Generated Hologram. According to this embodiment, responsive to a determination that all layers of the multi-layer image corresponding respectively to layers of the multi-layer Computer Generated Hologram that are between the at least one layer of the multi-layer Computer Generated Hologram and the last layer of the multi-layer Computer Generated Hologram, have not changed with respect to corresponding layers of a reference multi-layer image, the at least one layer of the multi-layer Computer Generated Hologram is obtained from a corresponding layer of a reference multi-layer Computer Generated Hologram, the reference multi-layer Computer Generated Hologram being previously reconstructed from the reference multi-layer image.

According to another aspect, an apparatus for reconstructing at least one Computer Generated Hologram from a multi-layer image is provided, wherein the apparatus comprising one or more processors configured for reconstructing at least one Computer Generated Hologram from a multi-layer image according to any one of the embodiments disclosed herein.

According to another aspect, a method for encoding a sequence of Computer Generated Holograms is provided, wherein a sequence of multiple plane images representative of the sequence of Computer Generated Holograms is encoded in a bitstream along with metadata used for reconstructing the sequence of Computer Generated Holograms. The sequence of multiple plane images is encoded according to any one of the embodiments described herein.

According to another aspect, a method for decoding a sequence of Computer Generated Holograms is provided, wherein a sequence of multiple plane images representative of the sequence of Computer Generated Holograms is decoded from a bitstream along with metadata used for reconstructing the sequence of Computer Generated Holograms. The sequence of multiple plane images is decoded according to any one of the embodiments described herein, and the sequence of Computer Generated Holograms is reconstructed according to any one of the embodiments described herein.

According to another aspect, an apparatus for encoding or decoding a sequence of Computer Generated Holograms is provided, wherein the apparatus comprises one or more processors configured for performing the steps of the method for encoding or decoding a sequence of Computer Generated Holograms according to any one of the embodiments described herein.

One or more embodiments also provide a computer program comprising instructions which when executed by one or more processors cause the one or more processors to perform any one of the methods according to any of the embodiments described above. One or more of the present embodiments also provide a computer readable storage medium having stored thereon instructions for encoding or decoding multiple plane images or Computer Generated Holograms, or reconstructing Computer Generated Holograms according to the methods described above. One or more embodiments also provide a computer readable storage medium having stored thereon a bitstream generated according to the methods described above. One or more embodiments also provide a method and apparatus for transmitting or receiving the bitstream generated according to the methods described above.

### BRIEF DESCRIPTION OF THE DRAWINGS

The present disclosure will be better understood, and other specific features and advantages will emerge upon reading the following description, the description making reference to the annexed drawings wherein:

FIG. 1 shows an example architecture of a device which may be configured to implement a method described in relation with any one of FIG. 3, 4, 6, 8, 9, 11, 14, 17, 18, 19, 20, according to a non-limiting embodiment of the present principles;

FIG. 2 illustrates an example of a layer-based representation of an object;

FIG. 3 illustrates an example of a method for determining a CGH from MPI, according to an embodiment,

FIG. 4 illustrates an example of a method for determining a CGH from MPI, according to another embodiment,

FIG. 5 illustrates an example of a multi-layer CGH;

FIG. 6 illustrates an example of a method for determining a CGH from MPI, according to another embodiment,

FIG. 7 illustrates a multi-layer CGH representation according to an embodiment of the present disclosure;

FIG. 8 illustrates an example of a method for determining a sequence of CGHs from e sequence of MPIs, according to an embodiment,

FIG. 9 illustrates an example of a method for determining a CGH from MPI, according to another embodiment;

FIG. 10 illustrates a multi-layer CGH representation according to another embodiment of the present disclosure;

FIG. 11 illustrates an example of a method for determining a sequence of CGHs from e sequence of MPIs, according to another embodiment;

FIG. 12 shows a non-limitative example of the encoding, transmission and decoding of data representative of a sequence of 3D scenes, according to a non-limiting embodiment of the present principles;

FIG. 13 illustrates the construction of an MPI-based atlas representative of a volumetric scene, according to a non-limiting embodiment of the present principles;

FIG. 14 shows a block diagram of a method for encoding a sequence of MPI according to an embodiment of the present principles,

FIG. 15 shows an example of an embodiment of the syntax of a stream when the data are transmitted over a packet-based transmission protocol, according to a non-limiting embodiment of the present principles;

FIG. 16 illustrates a spherical projection from a central point of view, according to a non-limiting embodiment of the present principles;

FIG. 17 shows a block diagram of a method for encoding a MPI according to an embodiment of the present principles,

FIG. 18 shows a block diagram of a method 1800 for decoding a sequence of MPI according to an embodiment of the present principles,

FIG. 19 shows a block diagram of a method 1900 for decoding a sequence of MPI according to another embodiment of the present principles,

FIG. 20 shows a block diagram of a method 2000 for decoding a MPI according to an embodiment of the present principles.

### DETAILED DESCRIPTION

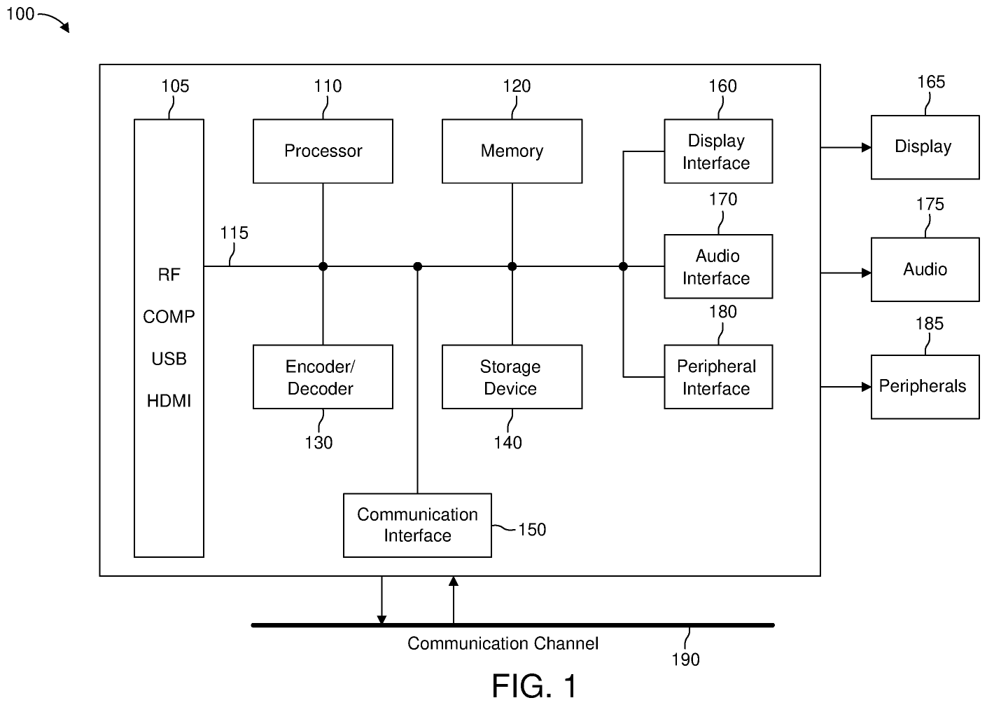

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video/3D scene or decoded video/3D scene, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video/3D scene, the decoded video/3D scene or portions of the decoded video/3D scene, the bitstream, matrices, variables, and intermediate or final results from the processing of equations, formulas, operations, and operational logic.

In some embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 100 may be provided through various input devices as indicated in block 105. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which can be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing, Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11 (IEEE refers to the Institute of Electrical and Electronics Engineers). The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105. As indicated above, various embodiments provide data in a non-streaming manner. Additionally, various embodiments use wireless networks other than Wi-Fi, for example a cellular network or a Bluetooth network.

The system 100 may provide an output signal to various output devices, including a display 165, speakers 175, and other peripheral devices 185. The display 165 of various embodiments includes one or more of, for example, a touchscreen display, an organic light-emitting diode (OLED) display, a curved display, and/or a foldable display. The display 165 can be for a television, a tablet, a laptop, a cell phone (mobile phone), or other device. The display 165 can also be integrated with other components (for example, as in a smart phone), or separate (for example, an external monitor for a laptop). The other peripheral devices 185 include, in various examples of embodiments, one or more of a stand-alone digital video disc (or digital versatile disc) (DVR, for both terms), a disk player, a stereo system, and/or a lighting system. Various embodiments use one or more peripheral devices 185 that provide a function based on the output of the system 100. For example, a disk player performs the function of playing the output of the system 100.

In various embodiments, control signals are communicated between the system 100 and the display 165, speakers 175, or other peripheral devices 185 using signaling such as AV.Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

The embodiments can be carried out by computer software implemented by the processor 110 or by hardware, or by a combination of hardware and software. As a non-limiting example, the embodiments can be implemented by one or more integrated circuits. The memory 120 can be of any type appropriate to the technical environment and can be implemented using any appropriate data storage technology, such as optical memory devices, magnetic memory devices, semiconductor-based memory devices, fixed memory, and removable memory, as non-limiting examples. The processor 110 can be of any type appropriate to the technical environment, and can encompass one or more of microprocessors, general purpose computers, special purpose computers, and processors based on a multi-core architecture, as non-limiting examples.

CGH and DH solve the convergence-accommodation conflict by recreating the exact same wave front as emitted by the initial 3D scene. For that, a hologram needs to be computed, which is done by computing the wave front emitted by the scene in the plane of the CGH, and associate it with a reference light, which will be used for playback (illumination of the hologram). In modern optics, wave front propagation is modeled through light diffraction, e.g., Fourier optics, and each point of the wave front can be considered as a secondary source emiting light.

One major aspect of CGH synthesis is thus evaluating the wave front emitted by a 3D object or scene toward a (hologram) plane. CGH can be synthesized from any form of 3D content, using different approaches. Two principal methods are used, based on point clouds or layered 3D scenes.

Various approaches to synthesizing CGH are possible. For example, one approach is based on Point Clouds. Another approach is based on Layered 3D scenes.

The point cloud approach involves computing the contribution of each point of a 3D scene to the illumination of each pixel of the hologram. Using this model, each point can be either considered as a perfect spherical emitter or described using Phong's model. The light field in the hologram plane is then equal to the summation of all points contributions, for each pixel. The complexity of this approach is proportional to the product of the number of points in the scene by the number of pixels, it thus implies an important computational load, and requires the computation of occlusions separately. The summation of each point and each pixel is described by the equations of Rayleigh-Sommerfeld or Huygens-Fresnel.

A three-dimensional scene can as well be described as a superposition of layers, considered as slices of the 3D scene. From this paradigm, the scene is described as a superposition of layers, to each of which is associated a depth in the scene. This description of a 3D scene is very well adapted to Fourier Transform models of diffraction. This is especially the case for the model of angular spectrum. The layer approach to compute CGHs has the advantage of low complexity and high computation speed due to the use of Fast Fourier Transform algorithms (FFT) embedded inside a Propagation Transform (PT), enabling the processing of a single layer at high speed. Some techniques were also designed to take care of occlusions, through the implementation of masks in active pixels, or ping-pong algorithms. One approach is to simulate propagation of light through the scene starting at the furthest layer, e.g., at a background layer. The light propagation is then computed from the furthest layer to the hologram plane, by layer-to-layer propagation transform. In detail, the light emitted by layer N received by the next layer plane N+1 is computed, and the contribution of this layer N+1 (meaning the light emitted by N+1) is added to the result. The light emitted by the layer N+1 is multiplied by the layer mask. The light emitted by layer N+1 is equal to the sum of both contributions.

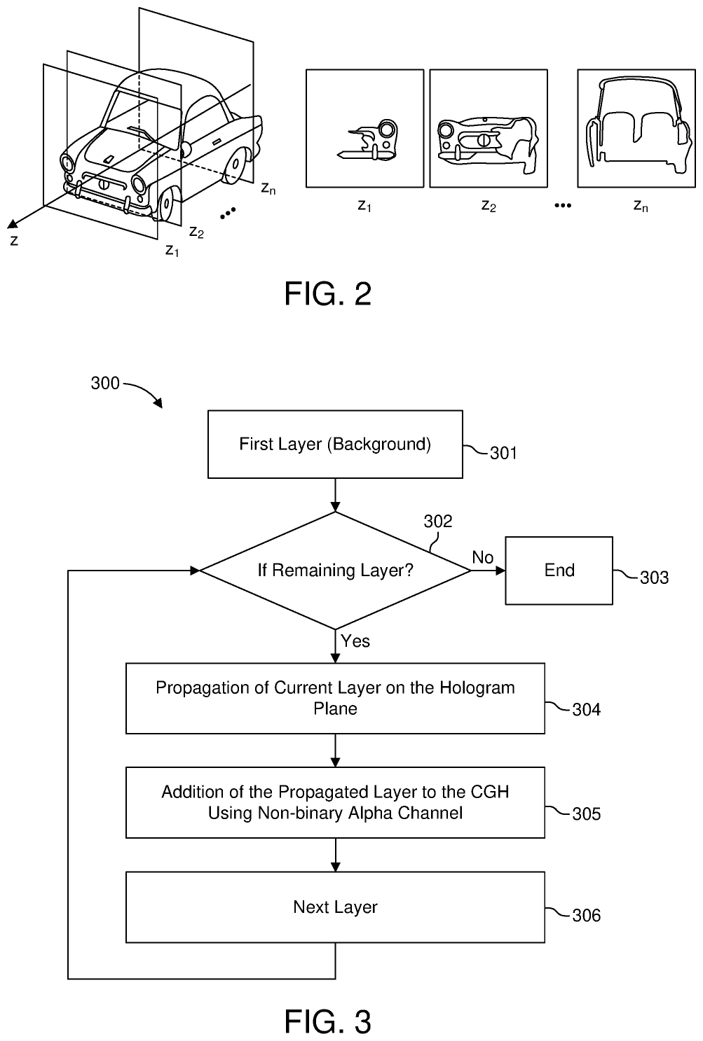

The layer-based method for the synthesis of CGHs is a fast-computational method. Multi-Plane Images (MPIs) is a particular case of layer content. MPIs involve a layer description of a 3D scene, almost always resulting from a multi-view scene, but could also possibly be obtained from a computer-generated scene. The MPI “format” can typically be considered as a set of fixed resolution (in pixels) images and a set of metadata gathering parameters like the depth of each image and focal length of the synthesis camera, to name but a few. FIG. 2 illustrates an example of a layer-based 3D scene wherein the 3D object is sliced into a set of n layers, each image layer l being associated to a depth zᵢ.

According to the present principles, MPI layers are applied to 3D images or 3D video contents that are represented in a layer-based format so as to generates Computer Generated Holograms. These layers may be represented as an orthographic projection of the scene or a perspective projection one. To address the issue of occlusion in a 3D scene, the layer-based content is composed of 4 channels, 3 textures R, G and B channels and a fourth channel corresponding to an alpha value. In “Soft 3d reconstruction for view synthesis”, E. Penner and L. Zhang, Proc. SIGGRAPH Asia, vol. 36, n° 6, 2017, Multi-Plane Image (MPI) representation is described as a perspective projection content with an alpha channel which is not binary. This nonbinary value is here to allow the rendering of different viewpoints of the scene with a smooth transition between objects at the border of an occlusion. The non-binary value helps to describe a probability for a given pixel in a given layer to be present. The non-binary value describes the contribution of a pixel of a layer to the computed CGH.

According to an aspect of the present disclosure, a method to construct a CGH from MPI is provided. According to an embodiment of the present aspect, information provided by the non-binary alpha channel is integrated in the CGH calculation. Several variants are possible for integrating the respective alpha parameter of a layer n in the CGH calculation.

According to a first embodiment, all the layers of the MPI are propagated directly to the hologram plan, using the following equations:

CGH(x, y, z)=ΣₗHₗ(x, y, zₗ) (1)

Where Hₗ(x, y, zₗ)=a(x, y, zₗ)*Holo(x, y, zₗ) (2)

Where CGH(x, y, z) is the computed hologram, Holo(x, y, zₗ) is the result of the propagation of the layer l to the hologram plane and a(x, y, zₗ) is the non-binary probability of the pixel (x, y) of the layer l.

According to this embodiment, all layers are propagated to the hologram plane. The resulting hologram is obtained by accumulating all the propagated layers (Equation (1)).

According to a second embodiment, each layer of the MPI is propagated to the next layer toward the hologram plane. For any layer l+1, the hologram at this layer is given by the following equation:

Hₗ₊₁(x, y, zₗ₊₁)=a(x, y, zₗ₊₁)×RGBₗ₊₁(x, y, zₗ₊₁)+Holoₗ₊₁(x, y, (zₗ−zₗ₊₁)) (3)

Where Hₗ₊₁(x, y, zₗ₊₁) is the hologram at the layer l+1 for the pixel (x, y), a(x, y, zₗ₊₁) is the non-binary probability of the pixel (x, y) of the layer l+1, RGBₗ₊₁(x, y, zₗ₊₁) is the texture of the layer l+1 and Holoₗ₊₁(x, y, (zₗ−zₗ₊₁)) is the propagation of the hologram layer at layer l to the layer l+1.

In general, if the scene consists in N×N points and the CGH has a size of N×N complex pixels, the calculation of a CGH requires calculation complexity of the order of o(N⁴). If instead of a point cloud, a plane image is used to generate the CGH, the calculation can be done with an FFT method whose complexity is reduced to o(2N²). If the scene is sliced into n layers, the complexity is finally n.o(2N²) which is two orders of magnitude less greedy than a method based on Point Clouds. This shows the interest of MPI representations of the scene. But even with this enormous gain in the mathematical complexity, the generation of a single frame CGH from one frame made out of MPI layers is very challenging on modern hardware equipment.

FIG. 3 illustrates an example of a method 300 for determining a CGH from MPI according to the first embodiment described above. In FIG. 3, operation begins at 301 with a first layer, e.g., a background layer, that is furthest from the result layer, e.g., the hologram layer or plane. At 302, the status of remaining layers is checked. That is, a check at 302 determines if there are additional layers other than the first layer to be considered. If not (“NO” at 302) then operation ends at 303 in that the wave front associated with the image information of the first layer propagates directly to the result layer. If there are additional layers (e.g., “YES” at 302) then operation continues at 304 where the propagation of a wave front associated with image information of the current layer directly to the result layer is determined. Then, at 305, the propagation of the layer to the result layer is added or combined with the propagation of other layers at the result layer to form the propagated wave front at the result layer. After 305, at 306 operation proceeds to the next layer and the check at 302 of remaining layer status. Thus, the wave front associated with the image information of each layer is propagated directly to the result layer and combined directly with the contributions of other layer. For example, the contributions from each of a plurality of layers to the result layer are each determined, e.g., for a first layer such as a background layer and one or more intermediate layers, and combined to form the result. In effect, the contribution of each layer is propagated directly to the result layer and combined at the result layer to form the propagated wave front at the result layer.

According to this embodiment, the final CGH is the accumulation of single layer transforms like it is also described by the equation related to the first embodiment above. The CGH is updated by the transformation of successive layers into a CGH. If the MPI has n layers, this means that n CGHs are calculated, but at the end, only the accumulation of all of them is available by the virtue of linearity of eq. 1.

In a variant, this embodiment can be implemented in a parallel fashion, wherein the layers are propagated to the Hologram plane in parallel. For example, a massively parallel processor (CPU) which can process m planes at a time can be used. This processor therefore propagates m planes at a time to the plane of the CGH where the results are added atomically (this means that as long as the result of the calculation of a pixel of the CGH is being incremented, it is “locked”, and another plane cannot add its contribution, as long as this pixel is locked. This process avoids, during parallel calculations that several processors are writing at the same time in memory). As soon as the processor has a free resource, another plane can be pushed for the calculation so that the processor occupancy rate is always maximum and equal to m.

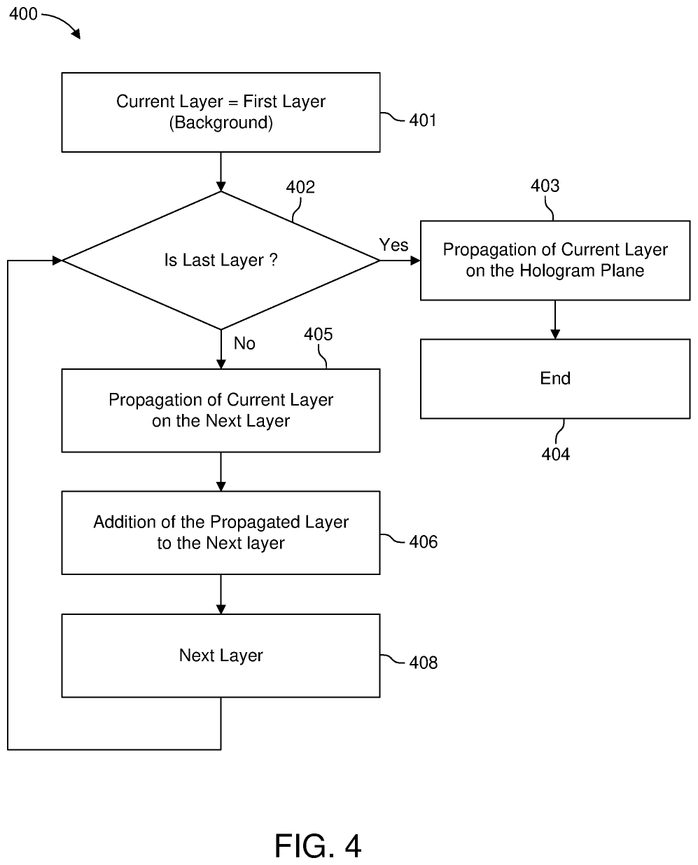

FIG. 4 illustrates an example of a method 400 for determining a CGH from MPI according to the second embodiment described above. In FIG. 4, operation begins at 401 with a first layer, e.g., a background layer, that is furthest from the result layer, e.g., the hologram layer or plane.

At 402, the status of remaining layers is checked. That is, a check at 402 determines if the current layer is the last layer to be considered. If this is the case (“YES” at 402) then propagation of image information of the current layer of the MPI to the result layer, e.g. the hologram plane, is determined at 403 to provide the propagated wave front at the result layer and operation ends at 404.

If the current layer is not the last one (e.g., “NO” at 402) then operation continues at 405 where the propagation of the current layer to the next layer is determined. For example, the propagation from the first layer, e.g., the background layer, to a second layer, e.g., an intermediate layer between the first layer and the result layer, is determined. At 406, the propagation to the next layer is combined with, e.g., added to, the next layer. In other words, the image information of the next MPI layer is added to the propagated current layer.

Then operation continues at 408 where the next layer is selected, by repetition of 402 for checking the last layer and propagation of the current layer to the next layer. Thus, operation at 402 through 408 repeat until all layers are considered to sequentially propagate the wave front from each layer to the next until the resulting wave front from the last layer propagates to the result layer to provide the propagated wave front at the result layer.

In the case of ‘video CGH’, a sequence of MPIs has to be considered, which means that a video consisting in multiple frames (i indicates a frame number, l indicates a layer number within that frame) of MPI. The workflows illustrated in FIGS. 3 or 4 need to be applied for each frame of the video CGH. At a time tᵢ, the CGH is calculated using the first or the second embodiment, and at time tᵢ+1, the next CGH frame is calculated by re-doing the same process. Thus, computing video or dynamic CGH can be time and resource consuming.

However, between an MPI at time tᵢ, and the MPI at time tᵢ+1, there is a very great probability that only some layers changed. In the case of a scene where an object is moving from one frame to the next one, but only on some layers between a background and a foreground for instance, then some layers of the MPI at tᵢ will remain the same at tᵢ+1. Therefore, this is a need for improving the CGH determination in the case of dynamic or video CGH.

According to an embodiment of the present disclosure, the methods described in FIGS. 3 and 4 are modified in order to store before addition each CGH corresponding to each layer (and not only the final CGH). To do so, a new layered structure is defined for the CGH, which is called a multi-layer CGH in the following. The layered-based CGH structure has a same number n of layers as each MPI from which it is determined. This new structure does not contain images but one CGH at each layer. It is a multi-layer CGH.

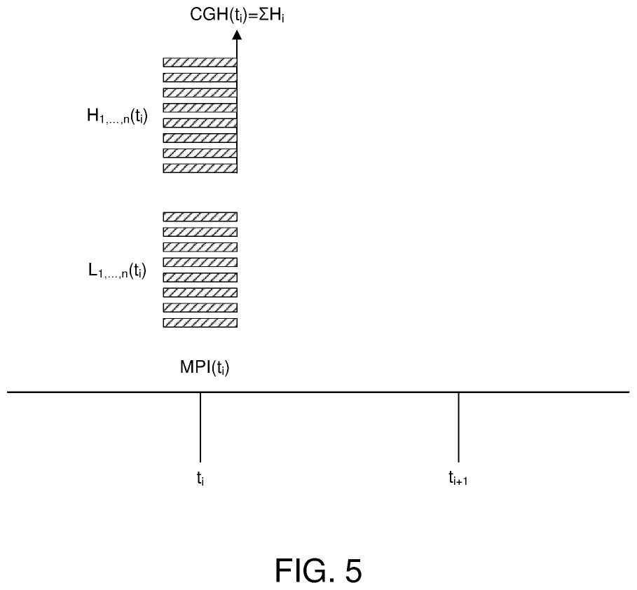

FIG. 5 shows that each MPI frame at time ti, MPI(ti), is composed out of n layers L_{1 , . . . , n}(ti). Corresponding to the MPI layers, there is a set of hologram layers H_{1 , . . . , n}(ti). The final CGH is the sum: CGH(ti)=ΣₗHₗ(ti), when the CGH is determined from the first embodiment described above.

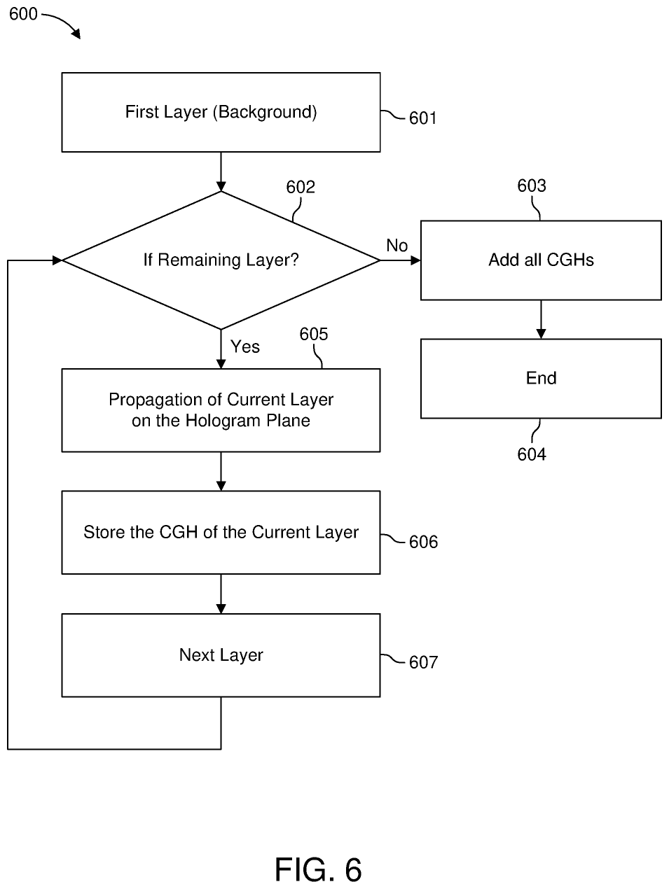

FIG. 6 illustrates an example of a method 600 for determining a CGH from MPI according to another embodiment. FIG. 6 shows an alternative determination for the first embodiment of the determination of CGH, where from the MPI layers, layers of CGHs (Hₗ(x, y, zₗ) from eq. 1) which consists in n different CGHs are determined and stored. Due to the linearity of eq. 1, it is only at the end that the final CGH is calculated but intermediate calculations are still available.

In FIG. 6, operation begins at 601 with a first layer, e.g., a background layer, that is furthest from the result layer, e.g., the hologram layer or plane. At 602, the status of remaining layers is checked. That is, a check at 602 determines if there are additional layers other than the first layer to be considered. If not (“NO” at 602) then at 603, all layers of the multi-layer CGH are accumulated in the result layer and operation ends at 604. If there are additional layers (e.g., “YES” at 602) then operation continues at 605 where the propagation of a wave front associated with image information of the current layer directly to the result layer is determined. Then, at 606, the CGH layer that is obtained at 605 from the propagation of the image layer is stored.

At 607, operation proceeds to the next layer and the check at 602 of remaining layer status.

According to this embodiment, the propagation of an image layer to the result layer is stored for each layer of the multi-layer CGH.

The propagated image layer is added or combined with the propagation of other layers at the result layer to form the propagated wave front at the result layer at 603, once all the image layers have been propagated and stored.

According to an embodiment of the present disclosure, each layer of a multi-layer CGH is now stored each time an image layer of the MPI used for generating the final CGH is propagated to the hologram plane. Thus, computing time and operations can thus be saved as it allows reusing already computed CGH layers when a MPI layer has not changed with respect to a MPI layer of a previous MPI.

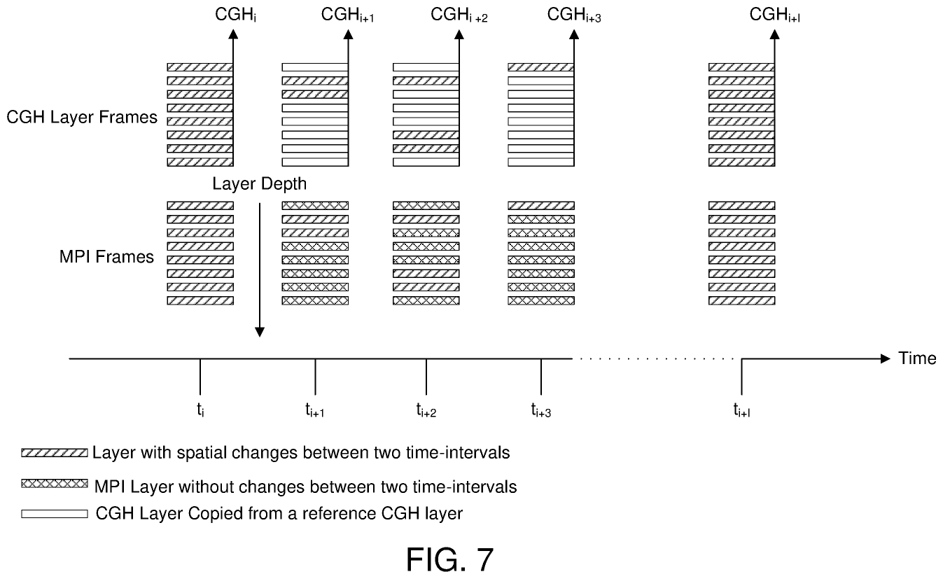

FIG. 7 illustrates a variant of the first embodiment for generating the CGH, wherein already determined CGH layers can be reused. In FIG. 7, each segment is a layer. FIG. 7 shows a set of segments (layers) for the MPI and a same number of layers for the corresponding Multi-Layered CGH, and this at each frame t. On FIG. 7, frames are represented from frames tᵢ to tᵢ₊ₗ. For MPI frames at tᵢ to tᵢ₊ₗ, segments with cross stripes indicate layers that do not change between two time-intervals tᵢ to tᵢ₊₁. Diagonal striped segments indicate layers that have some spatial changes from frame at tᵢ to tᵢ₊₁. For the CGH Layer frames, diagonal striped segments indicate the layers that have been computed from the corresponding MPI layer at the same instant tᵢ. Blank segments indicate layers that have been copied from a reference CGH layer frame to the CGH layer frame at tᵢ.

According to a variant, the reference CGH layer frame is the corresponding layer of the previous multi-layer CGH determined at time tᵢ₋₁. In another variant, the reference CGH layer frame is a corresponding layer of a first multi-layer CGH of a group of multi-layer CGH, such as an Intra picture in video.

By analogy with video coding terms, if at time tᵢ, all CGH layers Hᵢ need to be computed, the frame tᵢ is called an intra frame. For instance, it may be the first CGH that is computed, in that case no previously stored multi-CGH is available.

The reasons for needing a reference frame, where all the calculations will be done, independently of a previous frame, are multiple:
All layers of the MPI have changed at time ti, because:
   It is the beginning of the video
   There is a scene cut
   There is a zooming or a panning.
   For some reason, it is decided to set the layers differently in depth.
At coding or decoding, there is a necessity to reset freshly the frame.

The notation Hₗ(tᵢ)=T[Lₗ(tᵢ)] is introduced. This means that the Hologram Hₗl(tᵢ) at layer l and frame tᵢ is the transformation T of the MPI layer l (Lₗ) at time tᵢ. Transformation in particular here means that a mathematical transformation is used to get from spatial images of a MPI layer to the Computer Generated Hologram at the corresponding layer. The transformation hence can be a Raleigh-Sommerfeld, Huygens-Fresnel, Fresnel or Fraunhoffer integral transform, Angular Spectrum of plane waves, Huygens convolution method, double-step Fresnel, or any other method used to calculate a hologram.

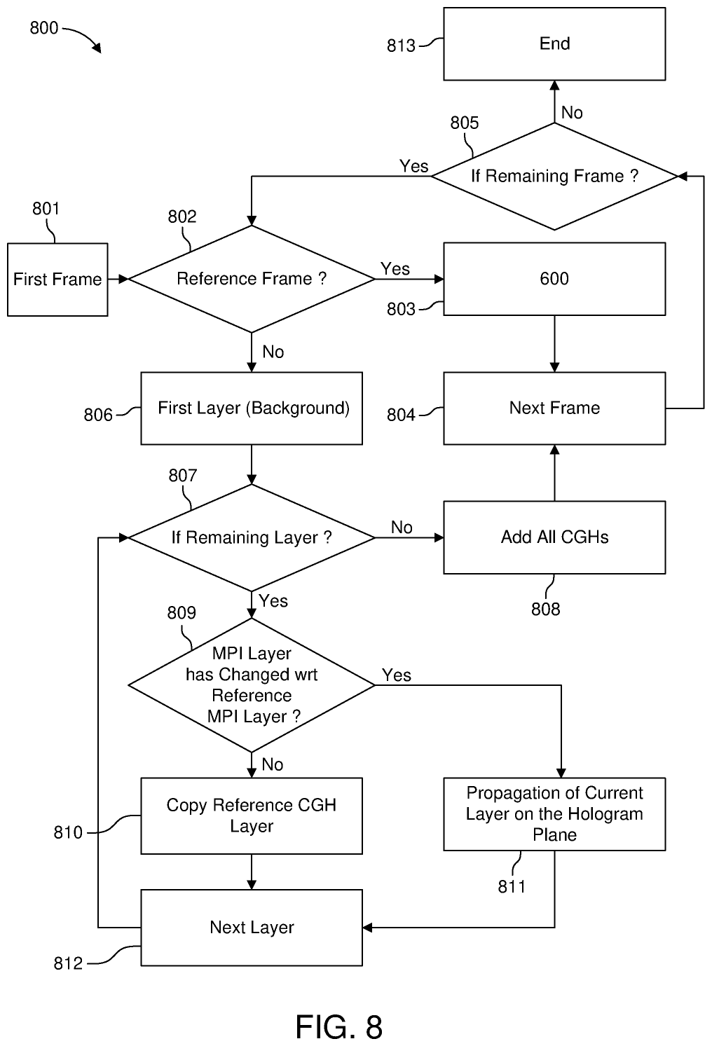

FIG. 8 illustrates an example of a method 800 for determining a sequence of CGHs from a sequence of MPIs according to the embodiment illustrated with FIG. 7. In FIG. 8, operation begins at 801 with a first frame of the sequence of MPIs that is used to generate a sequence of CGHs. At 802, it is determined whether the current frame is a reference frame or not. When the current frame is a first frame, there is no previously stored multi-layer CGH, so the first frame is always a reference frame.

If the current frame is a reference frame (YES at 802), all the layers of the multi-layer CGH have to be computed, then operation continues at 803 wherein the steps of method 600 described with FIG. 6 are performed with the current MPI frame as input. Then, at 804, operation proceeds to the next frame and at 805, it is determined if there are remining frames to process. If not (NO at 805), then, operation ends at 813.

If there are remaining frames to process (YES at 805), then, operation continues at 802 with the check of whether the current frame is a reference frame.

If not, (NO at 802), the generation of the CGH from the current MPI begins at 806 with a first layer, e.g., a background layer, that is furthest from the result layer, e.g., the hologram layer or plane. At 807, the status of remaining layers is checked. That is, a check at 807 determines if there are additional layers other than the first layer to be considered. If not (“NO” at 807) then at 808, all layers of the multi-layer CGH are accumulated in the result layer and operation continues at 804 to the next frame.

If there are additional layers (e.g., “YES” at 807) then operation continues at 809 where it is determined whether the current layer of the current MPI has changed with respect to a corresponding layer of the reference MPI. If not (NO at 809), then at 810, the current layer of the multi-layer CGH is set to the corresponding layer of the reference multi-layer CGH, which has been previously determined. In other words, the corresponding layer of the reference multi-layer CGH is copied to the current layer of the multi-layer CGH.

If the current layer of the current MPI has changed with respect to a corresponding layer of the reference MPI (YES at 809), at 811, the propagation of a wave front associated with image information of the current layer directly to the result layer is determined.

Then, after 811 or 810, operation proceeds to the next layer at 812, and the check at 807 of remaining layer status.

According to the embodiment, when a layer of the MPI has not changed with respect to a corresponding layer of a reference MPI, the corresponding layer of the multi-layer CGH is not computed, but retrieved from the previously computed layer of the reference multi-layer CGH.

A corresponding layer of a current layer should be understood here as a layer associated to a same depth as the current layer.

Below is presented an example of an algorithm performing another variant of the embodiment described with FIG. 8.

```
Algorithm:
  Set number of layers = n
  On frame i and While(frame i+1 !=end)
  Increment frame from i to i+1 and time to tᵢ₊₁
  Begin : Calculate CGH frame ?
    Yes: for each I in [1,n ]
      H_{I}(tᵢ₊₁)= T[L_{I}(tᵢ₊₁)]
      Store T[L_{I}(tᵢ₊₁)]
    No: for each I in [1,n ]
      If L_{I}(tᵢ₊₁)= L_{I}(tᵢ)
        H_{I}(tᵢ₊₁)= H_{I}(tᵢ)
      Else
        H_{I}(tᵢ₊₁)= T[L_{I}(tᵢ₊₁)]
        Store T[L_{I}(tᵢ₊₁)]
      Endif
  End: Calculate Reference frame ?
  $CGH ( ti ) = {\sum }_{l} {H}_{l} ( ti )$
  End While
```

In this variant, the “Calculate CGH frame?” test checks whether the current frame of the CGH need to be computed from equation(1). If there is already a previously stored multi-layer CGH or if the current frame is not a refresh frame, then it is checked for each layer of the current MPI whether the layer has changed with respect to the corresponding layer of the previous MPI frame. According to this variant, the reference frame is the previous frame in the sequence. When the MPI layer of the current frame has changed with respect to the corresponding layer of the reference frame, the CGH layer is determined from equation (1) and stored for future use as a reference CGH layer. This variant can be implemented with the method steps described with FIG. 8 with an additional step (not shown in FIG. 8) after 811 wherein the current layer that has been propagated at 811 is stored in memory for future use as a reference.

It can be seen that an enormous amount of time is saved, as the transformations T, which are very greedy, are only applied on layer that changed at each frame.

Note that the MPI layers at instants tᵢ and tᵢ₊₁ do not need to be equal in a strict sense. E.g. the similarity between both occurrences of the layers at instants tᵢ and tᵢ₊₁ can be computed, whatever the metric used, and the result can be tested against a predetermined value.

As the number of layers can be consequent, the gain also. Of course, some filming operations like zooming and panning will not generate any economy in the number of calculations, but as with any volumetric visual experience, the accumulated knowledge from 3D theatrical projections has shown to the story tellers that with this type of content, it is best to use those kinds of filming with parsimony, the spectator needs to have time to explore a scene to use the full potential of the added 3rd dimension.

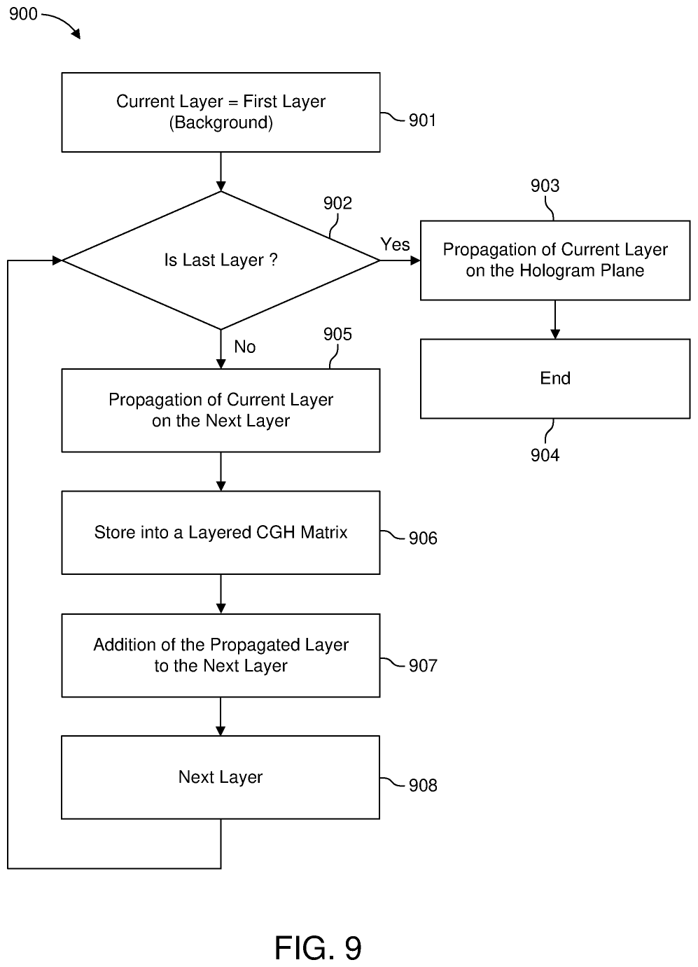

FIG. 9 illustrates an example of a method 900 for determining a CGH from MPI according to another embodiment. FIG. 9 shows an alternative determination for the second embodiment of the determination of CGH according to which a layer of the MPI is propagated to a plane of a next layer. According to this embodiment, propagated layers are stored.

In FIG. 9, operation begins at 901 with a first layer, e.g., a background layer, that is furthest from the result layer, e.g., the hologram layer or plane. At 902, the status of remaining layers is checked. That is, a check at 902 determines if the current layer is the last layer to be considered. If this is the case (“YES” at 902) then propagation of the current layer to the result layer, e.g. the hologram plane, is determined at 903 to provide the propagated wave front at the result layer and operation ends at 904.

If the current layer is not the last one (e.g., “NO” at 902) then operation continues at 905 where the propagation of the current layer to the next layer is determined. For example, the propagation from the first layer, e.g., the background layer, to a second layer, e.g., an intermediate layer between the first layer and the result layer, is determined. At 906, the propagated layer is stored into a layered CGH matrix, i.e. the multi-layer CGH.

At 907, the propagation to the next layer is combined with, e.g., added to, the next layer. In other words, the image information of the next MPI layer is added to the propagated current layer.

Then operation continues at 908 where the next layer is selected, by repetition of 902 for checking the last layer and propagation of the current layer to the next layer. Thus, operation at 902 through 908 repeat until all layers are considered to sequentially propagate the wave front from each layer to the next until the resulting wave front from the last layer propagates to the result layer to provide the propagated wave front at the result layer.

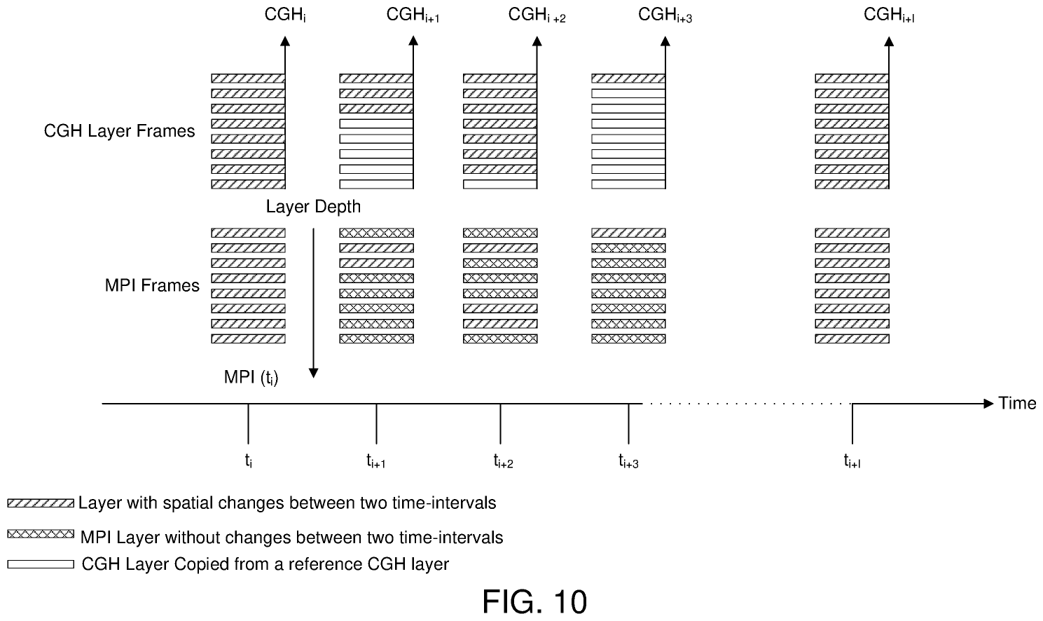

FIG. 10 illustrates a variant of the second embodiment for generating the CGH, wherein already determined CGH layers can be reused. However, according to this embodiment, as an MPI layer is propagated to a next layer of the MPI rather than directly on the hologram plane, as soon as one layer has changed in the MPI, the transform T for all remaining layers from that one to the CGH plane has to be calculated.

Each segment is a layer. For MPI frames i to i+l, segments with cross stripes indicate layers that do not change between two time-intervals i and i+1. Diagonal striped Segments indicate layers that have some spatial changes from frame i to the frame i+1. For the CGH Layer frames, diagonal striped segments indicate the layers that have been computed from the corresponding MPI layer at the same instant tᵢ. Blank segments indicate layers that have been copied from the previous CGH layer frame i−1 to the CGH layer frame i.

As can be seen from FIG. 10, the propagation is sequential from the far most layer of the MPI (greatest depth layer is at the bottom of the layer stack). From equation (3) for this embodiment: the MPI layer l which is the farthest from the CGH plane is first transformed, and propagated to the layer l+1, where it is multiplied by the RGBa image, before being propagated again to l+2, and so on up to the CGH plane. This means that if one layer x of the MPI has changed between frame i and i+1, only CGH layers before x (from n included to x excluded [n,x[), are copied without change from CGH frame i. All layers from [x, 1] have to be computed.

It could noted that, when in the first embodiment for generating the CGH, the layers contribution is computed in the plane of the CGH, in the second embodiment for generating the CGH, each layer has a contribution not in the CGH plane but in the plane of the next layer in line, in the direction of the CGH plane. Such a propagation can then be seen as a “chain” of still layers, which would be broken by any changing layer. If any link in the chain is replaced (i.e. the layer changes), all the part of the chain between the link (included) and the CGH plane is replaced (i.e. the propagation from this layer is computed all the way again from the contribution of the last still layer).

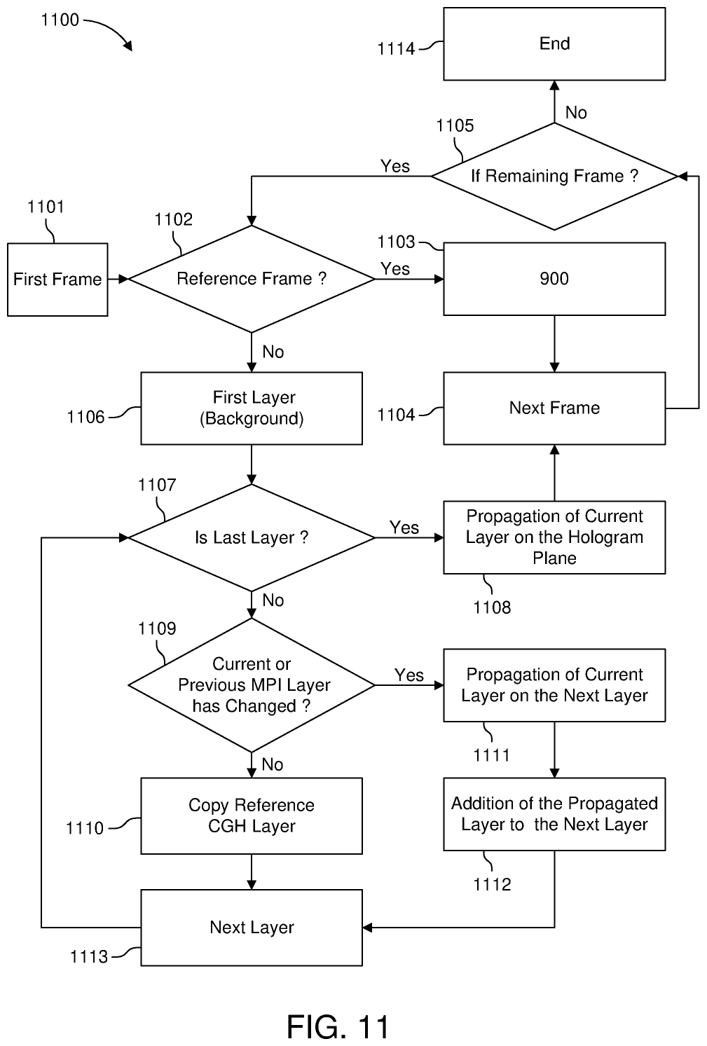

FIG. 11 illustrates an example of a method 1100 for determining a sequence of CGHs from a sequence of MPIs according to the embodiment illustrated with FIG. 10. In FIG. 11, operation begins at 1101 with a first frame of the sequence of MPIs that is used to generate a sequence of CGHs. At 1102, it is determined whether the current frame is a reference frame or not. When the current frame is a first frame, there is no previously stored multi-layer CGH, so the first frame is always a reference frame.

If the current frame is a reference frame (YES at 1102), all the layers of the multi-layer CGH have to be computed, then operation continues at 1103 wherein the steps of method 900 described with FIG. 9 are performed with the current MPI frame as input. Then, at 1104, operation proceeds to the next frame and at 1105, it is determined if there are remining frames to process. If not (NO at 1105), then, operation ends at 1113.

If there are remaining frames to process (YES at 1105), then, operation continues at 1102 with the check of whether the current frame is a reference frame.

If not, (NO at 1102), the generation of the CGH from the current MPI begins at 1106 with a first layer, e.g., a background layer, that is furthest from the result layer, e.g., the hologram layer or plane.

At 1107, the status of remaining layers is checked. That is, a check at 1107 determines if the current layer is the last layer of the current MPI frame to be considered. If this is the case (“YES” at 1107) then propagation of the current layer to the result layer, e.g. the hologram plane, is determined at 1108 to provide the propagated wave front at the result layer and operation continues at 1104 to the next frame.

If the current layer is not the last one (e.g., “NO” at 1102) then operation continues at 1109 where it is determined whether the current layer of the current MPI or a previous layer of the current MPI has changed with respect to a corresponding layer of the reference MPI. If not (NO at 1109), then at 1110, the current layer of the multi-layer CGH is set to the corresponding layer of the reference multi-layer CGH, which has been previously determined and stored. In other words, the corresponding layer of the reference multi-layer CGH is copied to the current layer of the multi-layer CGH.

If the current layer of the current MPI or a previous layer of the current MPI has changed with respect to a corresponding layer of the reference MPI (YES at 1109), at 1111, the propagation of the current layer to the next layer is determined. At 1112, the propagation to the next layer is combined with, e.g., added to, the next layer. In other words, the image information of the next MPI layer is added to the propagated current layer.

Then, after 1112 or 1110, operation proceeds to the next layer at 1113, and the check at 1107 of remaining layer status.

According to the embodiment described above, when the current layer of the MPI and all the previous layers have not changed with respect to their corresponding layer of a reference MPI, the current layer of the multi-layer CGH is not computed but retrieved from the previously computed layer of the reference multi-layer CGH.

Below, an example of an algorithm performing the above described embodiment is presented:

```
Set number of layers = n
On frame i and While(frameᵢ₊₁ != end)
  Increment frame from i to i+1 and time to tᵢ₊₁
    Begin : Calculate CGH frame ?
      Yes: for each I in [n, 1]
      H_{I}(tᵢ₊₁)=RGBa_{I}(tᵢ₊₁) +T[L_{I-1}(tᵢ₊₁)]
      Store T[L_{I-1}(tᵢ₊₁)]
      No:
      broken=0
      for each I in [n, 1]
        if L_{I}(tᵢ₊₁)= L_{I}(tᵢ) and broken=0
          H_{I}(tᵢ₊₁)= H_{I}(tᵢ)
        Else
          broken=1
          H_{I}(tᵢ₊₁)= RGBa_{I}(tᵢ₊₁) + T[L_{I-1}(tᵢ₊₁)]
          Store T[L_{I-1}(tᵢ₊₁)]
        endif
      end for loop
    End: Calculate Reference frame ?
  CGH(tᵢ₊₁)= H_{I}(tᵢ₊₁)
End While
```

In this variant, the “Calculate CGH frame?” test checks whether the current frame of the CGH need to be computed from equation (3). If there is already a previously stored multi-layer CGH or if the current frame is not a refresh frame, then it is checked for each layer of the current MPI whether the current layer or a previous layer has changed with respect to the corresponding layer of the previous MPI frame.

According to this variant, the reference frame is the previous frame in the sequence. When the current MPI layer of the current frame or a previous layer has changed with respect to its corresponding layer of the reference frame, the CGH layer is determined from equation (3) and the propagation of the previous layer on the current one is stored for future use as a reference CGH layer.

This variant can be implemented with the method steps described with FIG. 11 with an additional step (not shown in FIG. 11) after 1111 and before 1112, wherein the current layer that has been propagated at 1111 is stored in memory for future use as a reference.

In that embodiment as well, the MPI layers at instants tᵢ and tᵢ₊₁ do not need to be equal in the strict sense. Like in the first embodiment, a similarity criterion between successive occurrences of the layers at instants tᵢ and tᵢ₊₁ can be computed, and the result can e.g. be tested against a predetermined threshold.

To be noted here: the for loops begin at the last layer n and it is proceeded from layer n to layer up to the layer one. The first one is the propagated to the CGH final plane CGH(tᵢ₊₁)=T[Hₗ(tᵢ₊₁)]. The summation takes place while the layer is propagated from last to first layer.

In the embodiments described above, the CGHs have been determined from an MPI content, difference between layers of a MPI of adjacent frames are estimated and the appropriate simplification in the CGH determination is performed.

According to an embodiment, the above-described embodiments for generating a sequence of CGHs from a sequence of MPIs can be used in a transmission system wherein the 3D scene is transmitted through a network as a set of MPIs and a sequence of CGHs is reconstructed from the transmitted and decoded set of MPIs. According to a variant, the set of MPIs is compressed following a MIV compression scheme (MDS20001_WG04_N00049, Text of ISO/IEC DIS 23090-12 MPEG Immersive Video).

In this case, the MPI is not transmitted as such but it is converted into a patch-based content. Each layer is converted into a set of patches. It is considered that a layer is static (not changing with respect to a corresponding layer of a reference frame) if all the patches belonging to this layer are static (not changing with respect to corresponding patches of the corresponding layer of the reference frame).

For initial use cases of MIV technology, at the decoder side, only a view synthesis of a given viewport was foreseen. The MPI structure that could be the input of the compression process is not supposed to be rendered at the decoding side. On the contrary, in case of the CGH application, the MPI must be reconstructed to apply the different transformation as described above. The idea of limiting the amount of calculation based on the content remains valid. It is possible to not reconstruct the whole MPI, if the layers that have not changed between successive frames are known. To simplify the reconstruction, before transmission, it is determined if a given layer has changed between successive frames. The similarity between both occurrences of the layers at instants tᵢ and tᵢ₊₁ can be computed, whatever the metric used, and the result can be tested against a determined value.

A set of metadata is then constructed by associating to each layer of each frame a binary information saying if this is a changing layer or not. This metadata stream is transmitted with the MIV content. At the decoding side, based on these metadata, if all the patches of a layer are marked as not changing patches, then the corresponding layer is not changing. The layers that are marked as not changing layers will not be reconstructed. The associated CGH layer will be directly copied from the corresponding CGH layer of the previous frame.

According to this embodiment, the check of whether of a current layer of a frame, or any previous layers of the current layer, has changed with respect to a corresponding of a reference frame (steps 809, 1109 in FIGS. 8 and 11 respectively), is performed based on a transmitted item indicating whether the current layer has changed or not.

Some variants of this embodiment are described below. It should be noted that the embodiments below are described in the case of 3D scenes rendered using Computer Generated Holograms, however these embodiments could be applied to any other 3D scenes rendering, and are not limited to Computed Generated Holograms. As will be seen below, the methods and systems described below can be applied in a general manner to any 3D scenes representation.

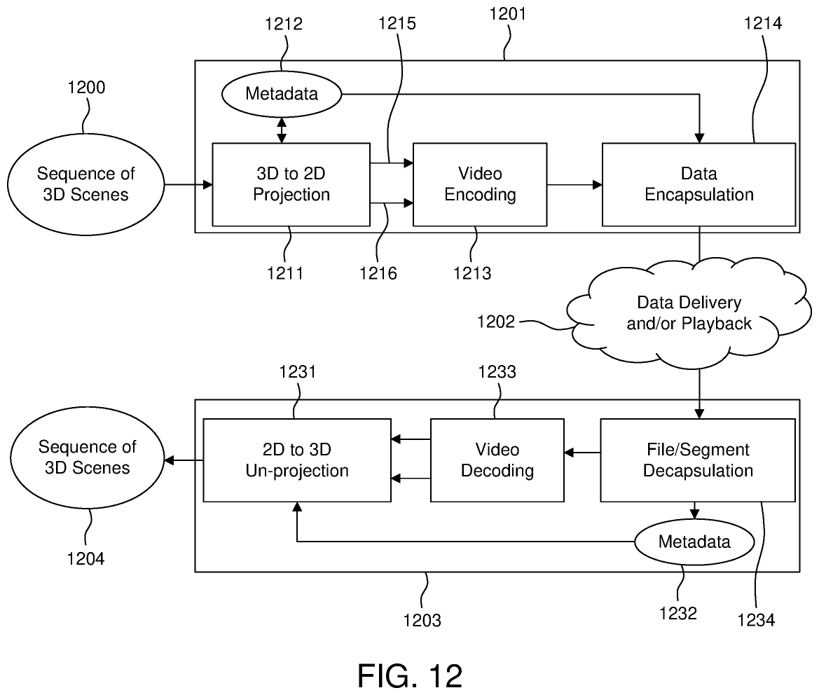

FIG. 12 shows a non-limitative example of the encoding, transmission and decoding of data representative of a sequence of 3D scenes. The encoding format that may be, for example and at the same time, compatible for 3DoF, 3DoF+ and 6DoF decoding.

A sequence of 3D scenes 1200 is obtained. As a sequence of pictures is a 2D video, a sequence of 3D scenes is a 3D (also called volumetric) video. A sequence of 3D scenes may be provided to a volumetric video rendering device for a 3DoF, 3Dof+ or 6DoF rendering and displaying. Sequence of 3D scenes 1200 is provided to an encoder 1201. The encoder 1201 takes one 3D scenes or a sequence of 3D scenes as input and provides a bit stream representative of the input. The bit stream may be stored in a memory 1202 and/or on an electronic data medium and may be transmitted over a network 1202. The bit stream representative of a sequence of 3D scenes may be read from a memory 1202 and/or received from a network 1202 by a decoder 1203. Decoder 1203 is inputted by said bit stream and provides a sequence of 3D scenes, for instance in a point cloud format.

Encoder 1201 may comprise several circuits implementing several steps. In a first step, encoder 1201 projects each 3D scene onto at least one 2D picture. 3D projection is any method of mapping three-dimensional points to a two-dimensional plane. As most current methods for displaying graphical data are based on planar (pixel information from several bit planes) two-dimensional media, the use of this type of projection is widespread, especially in computer graphics, engineering and drafting. Projection circuit 1211 provides at least one two-dimensional frame 1215 for a 3D scene of sequence 1200. Frame 1215 comprises color information and depth information representative of the 3D scene projected onto frame 1215. In a variant, color information and depth information are encoded in two separate frames 1215 and 1216.

Metadata 1212 are used and updated by projection circuit 1211. Metadata 1212 comprise information about the projection operation (e.g. projection parameters) and about the way color and depth information is organized within frames 1215 and 1216.

A video encoding circuit 1213 encodes sequence of frames 1215 and 1216 as a video. Pictures of a 3D scene 1215 and 1216 (or a sequence of pictures of the 3D scene) is encoded in a stream by video encoder 1213. Then video data and metadata 1212 are encapsulated in a data stream by a data encapsulation circuit 1214.

Encoder 1213 is for example compliant with an encoder such as:
JPEG, specification ISO/CEI 10918-1 UIT-T Recommendation T.81, https://www.itu.int/rec/T-REC-T.81/en;
AVC, also named MPEG-4 AVC or h264. Specified in both UIT-T H.264 and ISO/CEI MPEG-4 Part 10 (ISO/CEI 14496-10), http://www.itu.int/rec/T-REC-H.264/en, HEVC (its specification is found at the ITU website, T recommendation, H series, h265, http://www.itu.int/rec/T-REC-H.265-201612-I/en);
3D-HEVC (an extension of HEVC whose specification is found at the ITU website, T recommendation, H series, h265, http://www.itu.int/rec/T-REC-H.265-201612-I/en annex G and I);
VP9 developed by Google; or
AV1 (AOMedia Video 1) developed by Alliance for Open Media.

The data stream is stored in a memory that is accessible, for example through a network 1202, by a decoder 1203. Decoder 1203 comprises different circuits implementing different steps of the decoding. Decoder 1203 takes a data stream generated by an encoder 1201 as an input and provides a sequence of 3D scenes 1204 to be rendered and displayed by a volumetric video display device, like a Head-Mounted Device (HMD) or an Holographic Display. In case of an Holographic display, there is one more step before the display performed by the decoder or an additional module that determines or calculates the CGH from the decoded content. Decoder 1203 obtains the stream from a source 1202. For example, source 1202 belongs to a set comprising:
a local memory, e.g. a video memory or a RAM (or Random-Access Memory), a flash memory, a ROM (or Read Only Memory), a hard disk;
a storage interface, e.g. an interface with a mass storage, a RAM, a flash memory, a ROM, an optical disc or a magnetic support;
a communication interface, e.g. a wireline interface (for example a bus interface, a wide area network interface, a local area network interface) or a wireless interface (such as a IEEE 802.11 interface or a Bluetooth® interface); and
a user interface such as a Graphical User Interface enabling a user to input data.

Decoder 1203 comprises a circuit 1234 for extract data encoded in the data stream. Circuit 1234 takes a data stream as input and provides metadata 1232 corresponding to metadata 1212 encoded in the stream and a two-dimensional video. The video is decoded by a video decoder 1233 which provides a sequence of frames. Decoded frames comprise color and depth information. In a variant, video decoder 1233 provides two sequences of frames, one comprising color information, the other comprising depth information. A circuit 1231 uses metadata 1232 to un-project color and depth information from decoded frames to provide a sequence of 3D scenes 1204. In case of Holographic content, the circuit 1231 uses calculated the CGH from the decoded content (color and eventually depth) according to any one of the embodiments described above. Sequence of 3D scenes 1204 corresponds to sequence of 3D scenes 1200, with a possible loss of precision related to the encoding as a 2D video and to the video compression.

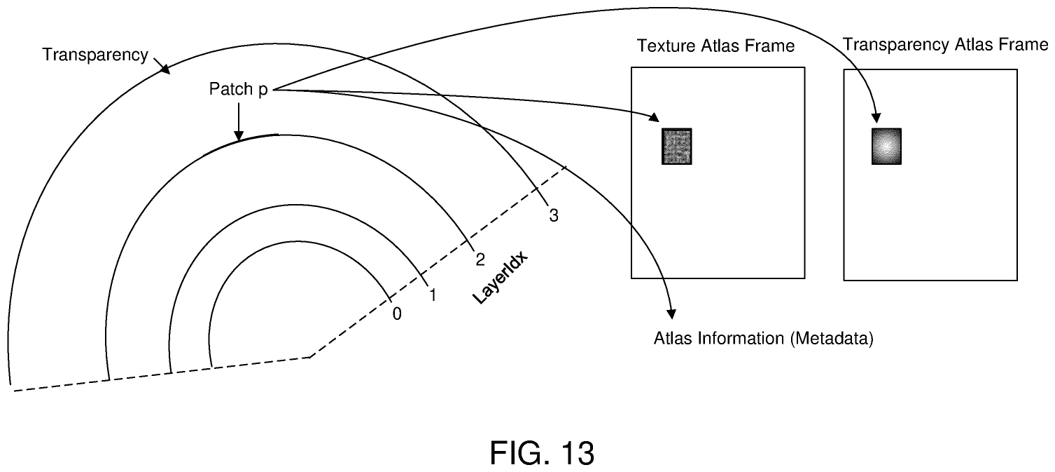

FIG. 13 illustrates the construction of an MPI-based atlas representative of a volumetric scene. A multiplane image (MPI) is a layered representation of a volumetric scene where each layer is actually a slice of the 3D space of the scene. Each slice is sampled according to an underlying central projection (e.g. perspective, spherical, . . . ) and a sampling law which defines the interlayer spacing. A layer comprises texture (i.e. color information) as well as transparency information of any 3D intersecting object of the scene. From this sliced representation, it is possible to recover/synthesize any viewpoint located in a limited region around the center of the underlying projection. It can be performed making use of efficient algorithms (e.g. “reversed” Painter's algorithm) which blends each layer with the proper weights (i.e. transparency) starting from the nearest to the furthest layer. Such techniques may run very much faster than other known view synthesis processes. The MPI may be conveyed as two video bitstreams respectively encoding texture and transparency patch atlas images. The depth (i.e. the geometry data corresponding to a distance between projected points of the 3D scene and the projection surface or projection center) of each patch is constant (because of the principles of MPI encoding) and may be signaled, for example, in an atlas information data stream and/or in metadata of one of the data streams or in metadata of one data stream encoding the two sequences of atlases in different tracks. Below is an example of a syntax for signaling the depth (pdu_depth_start) of the patch p located at spatial position pdu_2d_pos_x, pdu_2d_pos_y in the atlas:

```
patch_data_unit( tileID, p ) {
  pdu_2d_pos_x [ tileID ][ p ]
  pdu_2d_pos_y [ tileID ][ p ]
  ...
  pdu_depth_start[ tileID ][ p ]
  ....
}
```

FIG. 14 shows a block diagram of a method 1400 for encoding a sequence of MPI representative of a 3D scene according to an embodiment of the present principles.

The sequence of MPI to encode is input to the process. At 1401, it is determined whether a previously decoded MPI is stored for use as a reference MPI. If there is no reference MPI stored, then, operation continues at 1404: the current MPI is encoded in a bitstream(1404). An example of an embodiment for encoding an MPI is described below in reference with FIG. 17. At 1405, metadata associated to the MPI are encoded in the bitstream or in a separate bitstream. The encoded MPI is then decoded and stored (1406) for future use as a reference MPI.

At 1401, if it is determined that a reference MPI is stored in memory, operation continues at 1402. At 1402, it is determined whether a current layer of the current MPI to encode has changed with respect to a corresponding layer of a previously stored reference MPI. A corresponding layer of a reference MPI is a layer having a same depth as the current layer of the current MPI. Step 1402 is performed for all layers of the MPI.

According to an embodiment, determining whether a layer of the current MPI has changed with respect to a corresponding layer of a reference MPI is based on similarity metric determined between the current layer and the corresponding layer. For instance, a distance can be computed between the two images of the layers and tested against a value. If the distance is below the value, it is determined that the current layer has not changed with respect to the corresponding layer of the reference MPI.

The current MPI is then encoded (1404) and metadata associated to the current MPI are encoded (1405).

According to an embodiment, at 1405, for each one of the layers of the current MPI, an indicator indicating whether the layer has changed with respect to a corresponding layer of the reference MPI is encoded with the metadata. According to this embodiment, even if the layer has not changed with respect to a corresponding layer in the reference MPI, the layer is encoded in the bitstream.

According to a variant, the indicator is encoded with layer-based data in the bitstream.

According to another variant, the MPI is not transmitted as such but it is pruned and converted into a patch-based content. Each layer is converted into a set of patches. According to this variant, the indicator is encoded at the patch level, i.e. with the patch data.

The current MPI is decoded and stored in memory (at 1406) for future use as a reference MPI. At 1407, it is checked whether all the MPI of the sequence have been processed. If there is no more MPI to encode, operation ends, otherwise, operation continues at 1401.

According to an embodiment of the present principles, the MPI is encoded according to the V3C/MIV specification. According to this embodiment, a flag is added in the atlas frame parameter set MIV extension syntax as follows: (added syntax elements are underlined)

### 8.2.1.4 Atlas Frame Parameter Set MIV Extension Syntax

| | Descriptor |
|---|---|
| afps_miv_extension( ) { | |
| if( !afps_lod_mode_enabled_flag ) { | |
| afme_{—}inpaint_{—}lod_{—}enabled_{—}flag | u(1) |
| if( afme_inpaint_lod_enabled_flag ) { | |
| afme_{—}inpaint_{—}lod_{—}scale_{—}x_{—}minus1 | ue(v) |
| afme_{—}inpaint_{—}lod_{—}scale_{—}y_{—}idc | ue(v) |
| } | |
| afme Static patch enabled flag | u(1) |
| } | |
| } | |

The added flag “afme Static patch enabled flag allows the definition of an indicator (called Static_patch) coded on 32 bits for example, giving for the next 32 frames, a binary value indicating if a corresponding patch is static (i.e. has not changed) with respect to a reference view. For instance, a value=1 indicates that the patch has not changed, a value=0 indicates that the patch has changed). The Static_patch value is given in the Patch data unit MIV extension syntax shown below. This value is effective for the next 32 frames or up to the next patch data.

### 8.2.1.7 Patch Data Unit MIV Extension Syntax

| | Descriptor |
|---|---|
| pdu_miv_extension( tileID, p ) { | |
| if(asme_max_entity_id > 0 ) | |
| pdu_{—}entity_{—}id[ tileID ][ p ] | u(v) |
| if( asme_depth_occ_threshold_flag ) | |
| pdu_{—}depth_{—}occ_{—}threshold[ tileID ][ p ] | u(v) |
| if( asme_patch_attribute_offset_enabled_flag ) | |
| for( c = 0; c < 3; c++ ) { | |
| pdu_{—}attribute_{—}offset[ tileID ][ p ][ c ] | u(v) |
| if( asme_inpaint_enabled_flag ) | |
| pdu_{—}inpaint_{—}flag[ tileID ][ p ] | u(1) |
| } | |
| if(afme Static patch enabled flag) { | |
| Static patch [tileID][p] | u(32) |
| } | |
| } | |

In another embodiment, the indicator indicating if a layer has changed with respect to a corresponding layer of a reference MPI, is transmitted using a MPI layer grid descriptive information describing the MPI structure and indicating for each layer of the MPI if the layer is new for each frame.

In the embodiments described above, the full MPI is available for CGH determination. A MPI distribution stage is added allowing full MPI to be distributed frame by frame.

According to another embodiment, it is considered the case where the MPI is transmitted through a network and it is compressed following a MPI based encoding scheme, but the transmitted MPI does not contain all layers but only new/updated ones.

To sustain such architecture a metadata format is used to describe MPI layer array and for each frame indicate if the transmitted MPI contains or not each layer. This metadata stream is transmitted with the MPI content. At the decoding side, all received new layers are decoded and reconstructed and full CGH is reconstructed using nay one of the embodiments described above. In other words, for the current MPI, when it is determined that a layer has not changed with respect to a corresponding layer of the reference MPI, this layer is not encoded in the bitstream.

In the variant wherein the MPI is patch-based encoded, since the encoder is manipulating only patches and not layers, a metadata of the presence of a given patch is transmitted for each frame. This metadata stream is transmitted with the MPI content.

In a similar manner as described above, section 8.2.1.4 and 8.2.1.7 of the V3C/MIV specification are modified as follows introducing the flag afme_Presence_patch_enabled_flag and the data Presence_patch for each patch.

### 8.2.1.4 Atlas Frame Parameter Set MIV Extension Syntax

| | Descriptor |
|---|---|
| afps_miv_extension( ) { | |
| if( !afps_lod_mode_enabled_flag ) { | |
| afme_{—}inpaint_{—}lod_{—}enabled_{—}flag | u(1) |
| if( afme_inpaint_lod_enabled_flag ) { | |
| afme_{—}inpaint_{—}lod_{—}scale_{—}x_{—}minus1 | ue(v) |
| afme_{—}inpaint_{—}lod_{—}scale_{—}y_{—}idc | ue(v) |
| } | |
| afme Presence patch enabled flag | u(1) |
| } | |
| } | |

### 8.2.1.7 Patch Data Unit MIV Extension Syntax

| | Descriptor |
|---|---|
| pdu_miv_extension( tileID, p ) { | |
| if(asme_max_entity_id > 0 ) | |
| pdu_{—}entity_{—}id[ tileID ][ p ] | u(v) |
| if( asme_depth_occ_threshold_flag ) | |
| pdu_{—}depth_{—}occ_{—}threshold[ tileID ][ p ] | u(v) |
| if( asme_patch_attribute_offset_enabled_flag ) | |
| for( c = 0; c < 3; c++ ) { | |
| pdu_{—}attribute_{—}offset[ tileID ][ p ][ c ] | u(v) |
| if( asme_inpaint_enabled_flag ) | |
| pdu_{—}inpaint_{—}flag[ tileID ][ p ] | u(1) |
| } | |
| if(afme Presence patch enabled flag){ | |
| Presence patch[tileID][p] | u(32) |
| } | |
| } | |

According to this embodiment, the indicator Presence_patch can be interpreted as an indicator indicating whether the layer to which the patch belongs has changed with respect to a corresponding layer of a reference MPI. It can be considered that if no patch is present for a layer of an MPI, the layer has not changed with respect to a corresponding layer of a reference MPI. In a similar manner, the indicator Presence_patch can be interpreted as an indicator indicating whether the patch has changed with respect to a corresponding patch of a corresponding layer of a reference MPI.

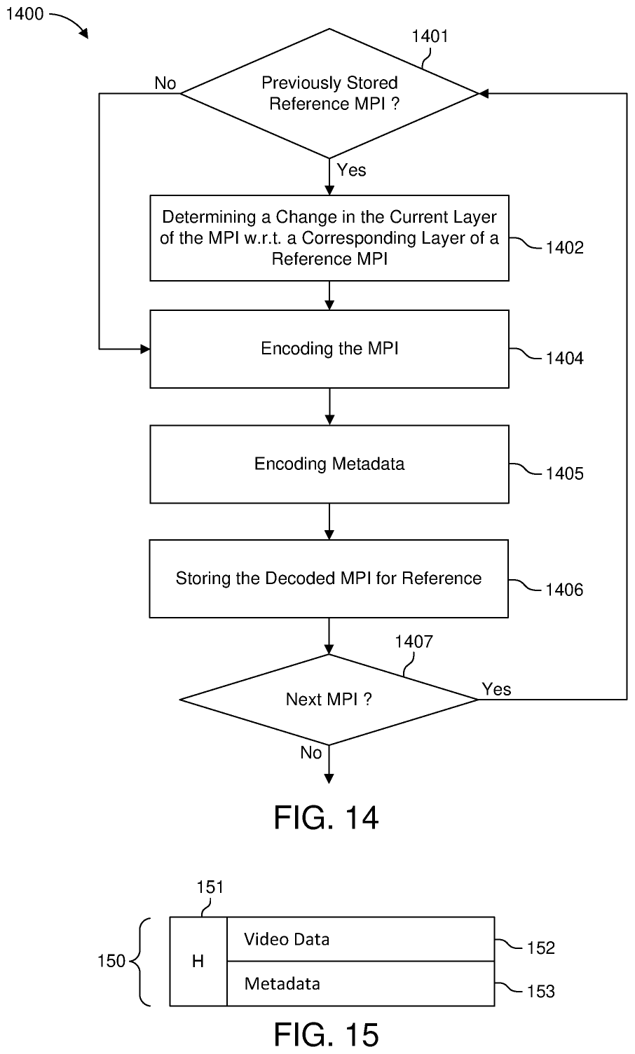

FIG. 15 shows an example of an embodiment of the syntax of a stream when the data are transmitted over a packet-based transmission protocol. FIG. 15 shows an example structure 150 of a volumetric video stream. The structure consists in a container which organizes the stream in independent elements of syntax. The structure may comprise a header part 151 which is a set of data common to every syntax elements of the stream. For example, the header part comprises some of metadata about syntax elements, describing the nature and the role of each of them. The header part may also comprise a part of metadata 1212 of FIG. 12, for instance the coordinates of a central point of view used for projecting points of a 3D scene onto frames 1215 and 1216. The structure comprises a payload comprising an element of syntax 152 and at least one element of syntax 153. Syntax element 152 comprises data representative of the color and depth frames. Images may have been compressed according to a video compression method.

Element of syntax 153 is a part of the payload of the data stream and comprises metadata about how frames of element of syntax 152 are encoded, for instance parameters used for projecting and packing points of a 3D scene onto frames. Such metadata may be associated with each frame of the video or to group of frames (also known as Group of Pictures (GoP) in video compression standards).

According to some embodiments, the metadata 153 comprises for at least one layer of a plurality of layers of at least one multiple plane image, an indicator indicating whether the at least one layer has changed with respect to a corresponding layer of a reference multiple plane image. According to another embodiment, metadata 153 comprises for at least one layer of the plurality of layers of the at least one multiple plane image, an indicator indicating whether the at least one layer is present in the bitstream, i.e. the video data 152.

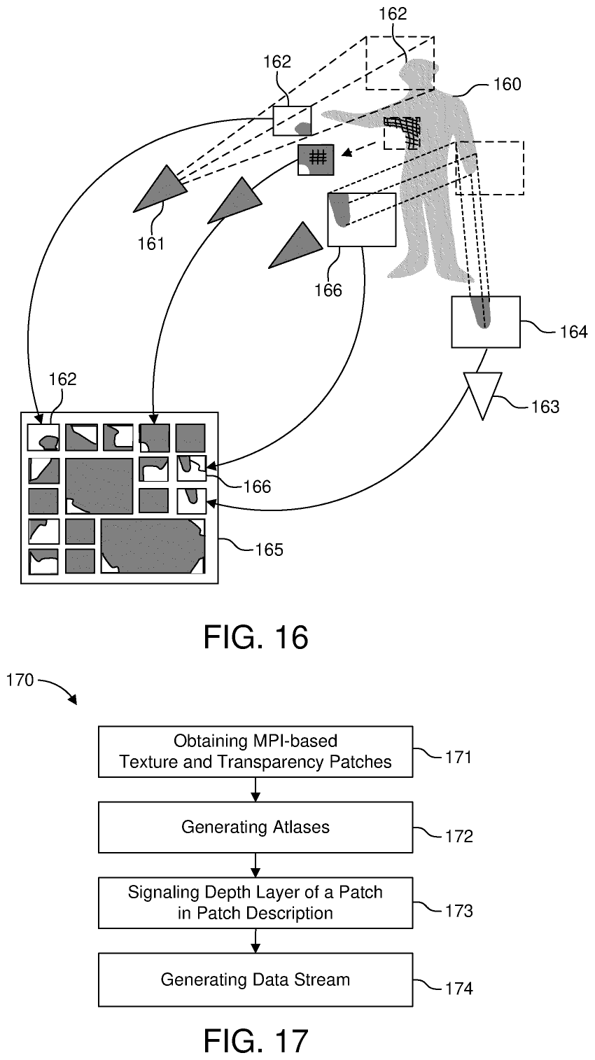

FIG. 16 illustrates the patch atlas approach with an example of 4 projection centers. 3D scene 160 comprises a character. For instance, center of projection 161 is a perspective camera and camera 163 is an orthographic camera. Cameras may also be omnidirectional cameras with, for instance a spherical mapping (e.g. Equi-Rectangular mapping) or a cube mapping. The 3D points of the 3D scene are projected onto the 2D planes associated with virtual cameras located at the projection centers, according to a projection operation described in projection data of metadata. In the example of FIG. 16, projection of the points captured by camera 161 is mapped onto patch 162 according to a perspective mapping and projection of the points captured by camera 163 is mapped onto patch 164 according to an orthographic mapping.

The clustering of the projected pixels yields a multiplicity of 2D patches, which are packed in a rectangular atlas 165. The organization of patches within the atlas defines the atlas layout. In an embodiment, two atlases with identical layout: one for texture (i.e. color) information and one for depth information. Two patches captured by a same camera or by two distinct cameras may comprise information representative of a same part of the 3D scene, like, for instance patches 164 and 166.

The packing operation produces a patch data for each generated patch. A patch data comprises a reference to a projection data (e.g. an index in a table of projection data or a pointer (i.e. address in memory or in a data stream) to a projection data) and information describing the location and the size of the patch within the atlas (e.g. top left corner coordinates, size and width in pixels). Patch data items are added to metadata to be encapsulated in the data stream in association with the compressed data of the one or two atlases.

FIG. 17 shows a block diagram of a method 170 for encoding a MPI-based 3D scene according to an embodiment of the present principles. At a step 171, a 3D scene is obtained, represented as a multi-plane image. Patches pictures are extracted from the different layers of the MPI representation. Patches are either texture patches (i.e. color values comprising a transparency value). At a step 172, these patches are packed in an atlas. In a variant, texture patches do not comprise a transparency value and corresponding transparency patches are obtained. In another embodiment, patches are packed in separate atlases according to their nature (i.e. texture or color, transparency, depth, . . . ). At a step 172, metadata are built to signal the elements of the representation. According to a variant, the number of depth layers of the MPI representation are encoded at a view level in the metadata. At a step 173, the depth layer a patch belongs to is signaled in a syntax structure representative of a description of the patch. At a step 174, generated atlases and generated metadata are encoded in a data stream.

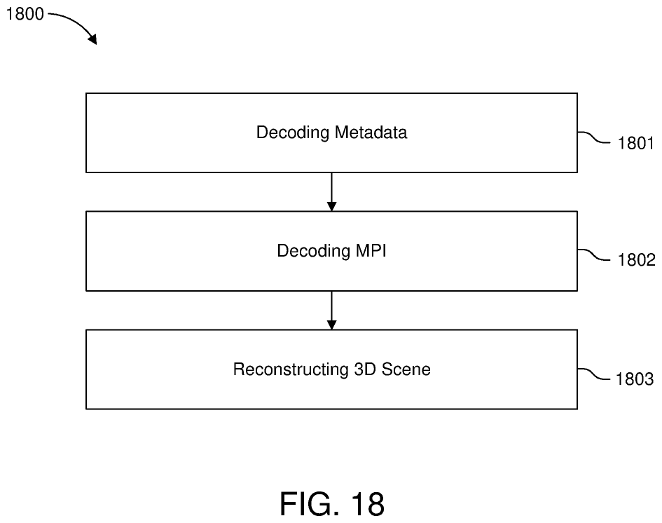

FIG. 18 shows a block diagram of a method 1800 for decoding a sequence of MPIs according to an embodiment of the present principles. At 1801, metadata is decoded from a bitstream, wherein the metadata comprises for at least one layer of the plurality of layers of a current MPI, an indicator indicating whether the at least one layer has changed with respect to a corresponding layer of a reference MPI. According to a variant, at 1802, the current MPI is decoded from the bitstream. Steps 1801 and 1802 are iterated until all MPIs of the sequence are decoded. At 1803, the 3D scene is reconstructed from the decoded MPIs and the decoded indicators indicating whether the at least one layer has changed.

For instance, at 1803, any one of the embodiments described above for reconstructing or generating a sequence of CGHs can be implemented. According to another embodiment, the 3D scene can be reconstructed using any other rendering methods, such as a method for rendering 3D data on Head Mounted Display.

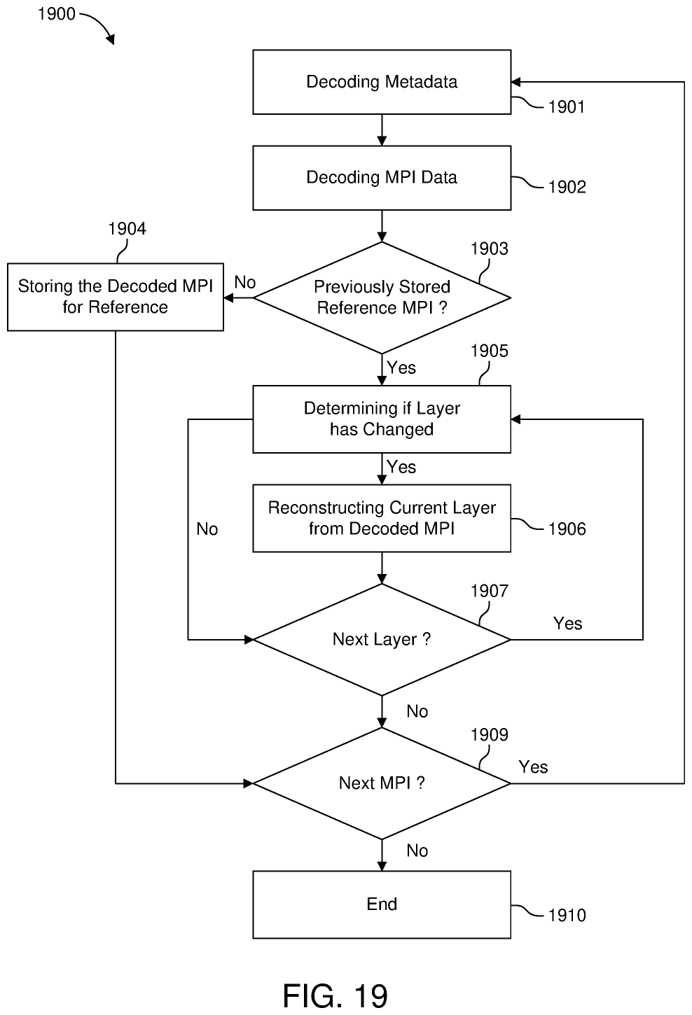

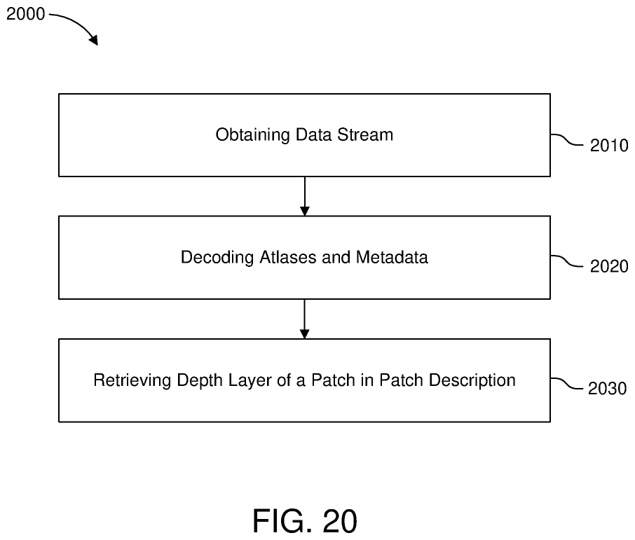

FIG. 19 shows a block diagram of a method 1900 for decoding a sequence of MPIs according to an embodiment of the present principles. At 1901, metadata is decoded from a bitstream, wherein the metadata comprises for at least one layer of the plurality of layers of a current MPI, an indicator indicating whether the at least one layer has changed with respect to a corresponding layer of a reference MPI. At 1902, encoded data of the current MPI is decoded from the bitstream. An example of a method for decoding encoded data of representative of an MPI is described below in relation with FIG. 20.

At 1903, a check determines whether a reference MPI has been previously stored. If not, (NO at 1903), then at 1904, all layers of the current MPI are reconstructed from the data decoded at 1902 and stored for future use as a reference. Then, operation continues at 1909 by checking if all remaining MPIs have been processed. If there is no remaining MPIs, then operation ends at 1910.

If there are other MPIs that have to be processed (YES at 1909), operation proceeds to the the next MPI and decoding of the metadata for the newly current MPI at 1901.

If at 1903, there is a reference MPI previously stored (YES at 1903), then operation proceeds at 1905 by determining whether the current layer has changed with respect to the corresponding layer of the reference MPI. The determination uses the indicator previously decoded from the bitstream for the current layer at 1901. If the indicator indicates that the current layer has changed (YES at 1905), then the current layer is reconstructed from the data decoded from the bitstream for the current MPI. If the current layer has not changed (NO at 1905), then the current layer of the MPI is not reconstructed. The corresponding layer of the reference MPI can be used as the current layer of the MPI when reconstructing the 3D scene from the MPIs.

At 1907, it is checked if all the layers of the current MPI have been processed. If there is more layers to process (YES at 1907), operation iterates at 1905. If all layers of the current MPI have been processed (NO at 1907), operation continues at 1909 with a next MPI, until all MPIs have been processed. According to this embodiment, the sequence of MPIs is reconstructed based on a reference MPI.

According to an embodiment, the method 1900 can be use in any one of the embodiments described above for reconstructing or generating a sequence of CGHs. The 3D scene is reconstructed from the reconstructed sequence of MPIs and the decoded indicators indicating whether the at least one layer has changed.

FIG. 20 shows a block diagram of a method 2000 for decoding a MPI according to an embodiment of the present principles. In this embodiment, the MPI has been encoded in a bitstream using a patch-based approach, e.g. using the method illustrated in FIG. 17. At a step 2010, a data stream representative of a Multi-plane image-based volumetric scene is obtained. At a step 2020, the data stream is decoded to retrieve at least one atlas image and associated metadata. In an embodiment, only one atlas is retrieved, pixels of the atlas embedding values of different natures comprising color, transparency and depth components. In another embodiment, several atlases are retrieved, pixels of one atlas comprising at least one of color, transparency and depth components, the three components being encoded in at least one atlas. At a step 2030, the depth layer a given patch is belonging to is retrieved from a syntax structure representative of a description of the patch in the metadata.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements as used herein are descriptive terms. As such, they do not preclude the use of other syntax element names.

This disclosure has described various pieces of information, such as for example syntax, that can be transmitted or stored, for example. This information can be packaged or arranged in a variety of manners, including for example manners common in video standards such as putting the information into an SPS, a PPS, a NAL unit, a header (for example, a NAL unit header, or a slice header), or an SEI message. Other manners are also available, including for example manners common for system level or application level standards such as putting the information into one or more of the following:
a. SDP (session description protocol), a format for describing multimedia communication sessions for the purposes of session announcement and session invitation, for example as described in RFCs and used in conjunction with RTP (Real-time Transport Protocol) transmission.
b. DASH MPD (Media Presentation Description) Descriptors, for example as used in DASH and transmitted over HTTP, a Descriptor is associated to a Representation or collection of Representations to provide additional characteristic to the content Representation.
c. RTP header extensions, for example as used during RTP streaming.
d. ISO Base Media File Format, for example as used in OMAF and using boxes which are object-oriented building blocks defined by a unique type identifier and length also known as ‘atoms’ in some specifications.
e. HLS (HTTP live Streaming) manifest transmitted over HTTP. A manifest can be associated, for example, to a version or collection of versions of a content to provide characteristics of the version or collection of versions.

When a figure is presented as a flow diagram, it should be understood that it also provides a block diagram of a corresponding apparatus. Similarly, when a figure is presented as a block diagram, it should be understood that it also provides a flow diagram of a corresponding method/process. The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example,, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

1. A method, comprising encoding a sequence of computer generated holograms the encoding comprising:
encoding in a bitstream, a sequence of multiple plane images representative of the sequence of computer generated holograms, and
encoding in the bitstream, for at least one layer of a plurality of layers of at least one multiple plane image of the sequence of multiple plane images, an indicator indicating whether the at least one layer has changed with respect to a corresponding layer of a reference multiple plane image of the sequence of multiple plane images.

2. An apparatus for encoding a sequence of computer generated holograms, the apparatus comprising one or more processors configured for:
encoding in a bitstream, a sequence of multiple plane images representative of the sequence of computer generated holograms,
encoding in the bitstream, for at least one layer of a plurality of layers of at least one multiple plane image of the sequence of multiple plane images, an indicator indicating whether the at least one layer has changed with respect to a corresponding layer of a reference multiple plane image of the sequence of multiple plane images.

3-7. (canceled)

8. A method, comprising decoding a sequence of computer generated holograms, comprising:
decoding from a bitstream, a sequence of multiple plane images representative of the sequence of computer generated holograms,
decoding from the bitstream, for at least one layer of a plurality of layers of at least one multiple plane image of the sequence of multiple plane images, an indicator indicating whether the at least one layer has changed with respect to a corresponding layer of a reference multiple plane image of the sequence of multiple plane images,
reconstructing at least one computer generated hologram of the sequence of computer generated holograms from the at least one multiple plane image based on the indicator indicating whether the at least one layer has changed.

9. An apparatus for decoding a sequence of computer generated holograms, the apparatus comprising one or more processors configured for:
decoding from a bitstream, a sequence of multiple plane images representative of the sequence of computer generated holograms,
decoding from the bitstream, for at least one layer of the plurality of layers of the at least one multiple plane image, an indicator indicating whether the at least one layer has changed with respect to a corresponding layer of a reference multiple plane image of the sequence of multiple plane images, and
reconstructing at least one computer generated hologram of the sequence of computer generated holograms from the at least one multiple plane image based on the indicator indicating whether the at least one layer has changed.

10. The method of claim 8, wherein each layer of the plurality of layers of the at least one multiple plane image is encoded as a set of patches, and wherein the indicator is encoded at a patch level.

11. (canceled)

12. The method of claim 3, wherein decoding the sequence of multiple plane images further comprises decoding, for the at least one layer of the plurality of layers of the at least one multiple plane image, an indicator indicating whether the at least one layer is present in the bitstream.

13. The method of claim 12, wherein the indicator indicating whether the at least one layer is present in the bitstream is encoded at a patch level.

14-15. (canceled)

16. The method of claim 8, wherein reconstructing the at least one computer generated hologram includes obtaining at least one layer of the computer generated hologram wherein:
responsive to a determination that a layer of the multiple plane image corresponding to the at least one layer of the computer generated hologram has not changed with respect to a corresponding layer of a reference multiple plane image, the at least one layer of the computer generated hologram is obtained from a corresponding layer of a reference computer generated hologram of the sequence of computer generated holograms, the reference computer generated hologram being previously reconstructed from the reference multiple plane image.

17. The apparatus of claim 9, wherein the one or more processors are further configured for reconstructing the at least one computer generated hologram by obtaining at least one layer of the computer generated hologram and responsive to a determination that a layer of the multiple plane image corresponding to the at least one layer of the computer generated hologram has not changed with respect to a corresponding layer of a reference multiple plane image, the at least one layer of the computer generated hologram is obtained from a corresponding layer of a reference computer generated hologram of the sequence of computer generated holograms, the reference computer generated hologram being previously reconstructed from the reference multiple plane imagegenerated holograms, the reference multi-layer computer generated hologram being previously reconstructed from the reference multi-layer image.

18. The method of claim 16, wherein;
responsive to a determination that the layer of the multiple plane image corresponding to the at least one layer computer generated hologram has changed with respect to the corresponding layer of the reference multiple plane image, the at least one layer of the computer generated hologram is obtained from a propagation of the layer of the multiple plane image toward a plane of the at least one computer generated hologram.

19. The method of claim 16, wherein reconstructing the computer generated hologram comprises accumulating each layer of the computer generated hologram.

20. The method of claim 8, wherein reconstructing at least one computer generated hologram comprises obtaining at least one layer of the at least one computer generated hologram,
wherein the computer generated hologram comprises a plurality of ordered layers, with a first layer being a layer that is a closest layer among the plurality of layers from a plane of the at least one computer generated hologram and a last layer being a farthest layer among the plurality of layers from a plane of the at least one computer generated hologram, and
wherein responsive to a determination that all layers of the multiple plane image corresponding respectively to layers of the computer generated hologram that are between the at least one layer of the computer generated hologram and the last layer of the computer generated hologram, have not changed with respect to corresponding layers of a reference multiple plane image, the at least one layer of the computer generated hologram is obtained from a corresponding layer of a reference computer generated hologram, the reference computer generated hologram being previously reconstructed from the reference multiple plane image.

21. The apparatus of claim 9, wherein the one or more processors are configured for reconstructing at least one computer generated hologram by obtaining at least one layer of the at least one computer generated hologram,
wherein the computer generated hologram comprises a plurality of ordered layers, with a first layer being a layer that is a closest layer among the plurality of layers from a plane of the at least one computer generated hologram and a last layer being a farthest layer among the plurality of layers from a plane of the at least one computer generated hologram, and
wherein responsive to a determination that all layers of the multiple plane image corresponding respectively to layers of the computer generated hologram that are between the at least one layer of the computer generated hologram and the last layer of the computer generated hologram, have not changed with respect to corresponding layers of a reference multiple plane image, the at least one layer of the computer generated hologram is obtained from a corresponding layer of a reference computer generated hologram, the reference computer generated hologram being previously reconstructed from the reference multiple plane image.

22. The method of claim 20, wherein
responsive to a determination that at least one layer of the multiple plane image corresponding respectively to a layer of the computer generated hologram that is between the at least one layer of the computer generated hologram and the last layer of the computer generated hologram; has changed with respect to a corresponding layer of a reference multiple plane image, the at least one layer of the computer generated hologram is obtained from the layer of the multiple plane image corresponding to the at least one layer of the computer generated hologram and a propagation toward the plane of the at least one layer of the computer generated hologram, of the layer of the computer generated hologram that precedes the at least one layer of the computer generated hologram when the layers of the computer generated hologram are scanned from the last layer toward the first layer.

23. The method of claim 20, wherein reconstructing the computer generated hologram comprises propagating the first layer of the computer generated hologram toward the plane of the computer generated hologram.

24. The method of claim 16, wherein determining whether a layer of the multiple plane image has changed with respect to a corresponding layer of the reference multiple plane image, is based on a similarity criterion determined between the layer of the multiple plane image and the corresponding layer of the reference multiple plane image.

25. The method of claim 24, wherein it is determined that the layer of the multiple plane image has not changed with respect to the corresponding layer of the reference multiple plane image, if the similarity criterion is below a first value.

26. The method of claim 16, wherein determining whether a layer of the multiple plane image has changed with respect to a corresponding layer of the reference multiple plane image, is based on the indicator indicating whether or not the at least one layer of the multiple plane image has changed with respect to the corresponding layer of the reference multiple plane image.

27-28. (canceled)

29. A computer readable medium comprising a bitstream comprising data representative of a sequence of multiple plane images representing a sequence of computer generated holograms, wherein the bitstream further comprises, for at least one layer of a plurality of layers of at least one multiple plane image, at least one of an indicator indicating whether or not the at least one layer has changed with respect to a corresponding layer of a reference multiple plane image of the sequence of multiple plane images or an indicator indicating whether or not the at least one layer is present in the bitstream.

30. (canceled)

31. A computer readable storage medium having stored thereon instructions for causing one or more processors to perform the method of claim 3.

32. (canceled)

33. The apparatus according to claim 4 comprising:
at least one of (i) an antenna configured to receive a signal, the signal including data representative of the sequence of multiple plane images, (ii) a band limiter configured to limit the received signal to a band of frequencies that includes the data representative of the sequence of multiple plane images, or (iii) a display configured to display the sequence of computer generated holograms.

34. The apparatus according to claim 33, wherein the display is a holographic display.

35-37. (canceled)
